(19) United States
(12) Patent Application Publication
(10) Pub. No.: US 2026/0318938 A1
(43) Pub. Date: Oct. 15, 2026

(54) BLOOD CELL SEPARATION APPARATUS, AUTOMATIC ANALYSIS APPARATUS, AND BLOOD CELL SEPARATION METHOD

(71) Applicant: CANON KABUSHIKI KAISHA, Tokyo (JP)

(72) Inventors: Kenta KAMINO, Tochigi (JP); Hiroto SATAKE, Brighton, MA (US); Keisuke SUGAHARA, Kanagawa (JP)

(73) Assignee: CANON KABUSHIKI KAISHA, Tokyo (JP)

(21) Appl. No.: 19/646,058

(22) Filed: Apr. 13, 2026

(30) Foreign Application Priority Data
Apr. 14, 2025 (JP) 2025-066296

(51) Int. Cl. G01N 35/10; B01D 21/01; B01D 21/28; B03C 5/02

(52) U.S. Cl. CPC G01N 35/1002; B01D 21/01; B01D 21/283; B03C 5/028; G01N 35/1004; B03C 2201/26; G01N 2035/1053

(57) ABSTRACT

A blood cell separation apparatus includes a blood dispensing unit configured to dispense blood from a sample container into a dispensing container unit, a reagent dispensing unit configured to dispense, into the dispensing container unit, a blood platelet aggregation reagent for aggregating blood platelets, and an external force field application unit configured to apply an external force field for separating a blood cell component from the blood to the dispensing container unit.

### CROSS-REFERENCE TO RELATED APPLICATIONS

This application is based upon and claims the benefit of priority from Japanese Patent Application No. 2025-066296, filed Apr.14, 2025, the entire contents of which are incorporated herein by reference.

### FIELD

Embodiments described in this specification and drawings relate generally to a blood cell separation apparatus, an automatic analysis apparatus, and a blood cell separation method.

### BACKGROUND

There has been conventionally known an inspection apparatus such as a biochemical inspection apparatus or an immunoassay apparatus that measures a substance contained in a blood plasma component or a blood serum component, by separating a blood cell component from blood. In such an inspection apparatus, centrifuge separation that uses a centrifuge separator is generally employed as a method of separating a blood cell component from blood. Nevertheless, in the case of using a centrifuge separator, a series of operations of separating a blood plasma component or a blood serum component from blood, and executing sampling require human intervention. If a blood plasma component or a blood serum component can be extracted from blood and measured in the inspection apparatus, workload in inspection are reduced. In view of the foregoing, in a case where an inspection apparatus that automatically performs blood cell separation from blood and performs measurement is considered, a method of automatizing these operations by integrating the inspection apparatus and the centrifuge separator can be considered. Nevertheless, because the centrifuge separator is large in size, the size of the inspection apparatus increases.

From such a background, the research and development of a technique of separating a blood cell component from blood using a relatively-small device like a microfluidic device is actively performed. In a blood cell separation method that uses such a device, there has been known a method of separating a blood cell component from blood by applying a physical force field such as dielectrophoretic force or acoustic radiation force from the outside of the device, and moving a blood cell by dielectrophoresis, acoustophoresis, or the like. Nevertheless, in these methods, the magnitude of force that acts on the particles changes depending on the diameter of the particles desired to be moved. For example, because dielectrophoretic force is proportional to the cube of a radius, the smaller the size of the particles, the smaller the magnitude of force that acts on the particles. Blood cell components of blood contain blood cells of various sizes such as white blood cells (10 to 20 μm), red blood cells (7 to 8 μm), and a blood platelet (1 to 2 μm). For this reason, it is necessary to form a force field for moving each type of blood cells.

In addition, regarding force such as dielectrophoretic force and acoustic radiation force, an application condition of an optimum force field varies depending on the diameter of the particles. Among these, because a blood platelet has a size of 1 to 2 μm, the blood platelet often requires a condition different from a condition for moving white blood cells and red blood cells. For example, in acoustophoresis, in the case of separating a blood platelet from blood, a mechanism that can execute higher-frequency output than that to be executed in the case of separating red blood cells and white blood cells is required. In addition, also in dielectrophoresis, a mechanism that can apply a high-voltage electric field to an electrode is required. In this manner, when blood cell components having a plurality of particles sizes are to be removed from blood, in the case of using a force field that depends on the diameter of the particles, such as dielectrophoresis or acoustophoresis, in order to remove a blood cell component with a small size such as a blood platelet, it is necessary to form a stronger force field as compared with the case of removing red blood cells or white blood cells.

### BRIEF DESCRIPTION OF THE DRAWINGS

FIG. 1 is a block diagram illustrating a configuration example of a blood cell separation apparatus according to a first embodiment;

FIG. 2 is a side view illustrating a configuration example of a probe unit in the blood cell separation apparatus according to the first embodiment;

FIG. 3A is a schematic diagram of a blood platelet and a capture molecule in the blood cell separation apparatus according to the first embodiment;

FIG. 3B is a schematic diagram of a particle in which a capture molecule is modified in the blood cell separation apparatus according to the first embodiment;

FIG. 4 is a perspective view illustrating a configuration example of a container unit in the blood cell separation apparatus according to the first embodiment;

FIG. 5 is a flowchart illustrating an operation example of the blood cell separation apparatus according to the first embodiment;

FIG. 6 is a partial cross-sectional view illustrating an operation example of the blood cell separation apparatus according to the first embodiment;

FIG. 7 is a partial cross-sectional view illustrating an operation example of the blood cell separation apparatus according to the first embodiment that follows FIG. 6;

FIG. 8 is a partial cross-sectional view illustrating an operation example of the blood cell separation apparatus according to the first embodiment that follows FIG. 7;

FIG. 9 is a partial cross-sectional view illustrating an operation example of the blood cell separation apparatus according to the first embodiment that follows FIG. 8;

FIG. 10 is a partial cross-sectional view illustrating an operation example of the blood cell separation apparatus according to the first embodiment that follows FIG. 9;

FIG. 11 is a partial cross-sectional view illustrating an operation example of the blood cell separation apparatus according to the first embodiment that follows FIG. 10;

FIG. 12 is a perspective view illustrating a configuration example of a container unit in a blood cell separation apparatus according to Modified Example 1 of the first embodiment;

FIG. 13 is a plan view illustrating a configuration example of an external force field generation unit in a blood cell separation apparatus according to Modified Example 2 of the first embodiment;

FIGS. 14A and 14B are plan views illustrating operation examples of the blood cell separation apparatus according to Modified Example 2 of the first embodiment;

FIG. 15 is a perspective view illustrating a configuration example of a dispensing container unit in a blood cell separation apparatus according to Modified Example 3 of the first embodiment;

FIG. 16 is a plan view illustrating a configuration example of a dispensing container unit in a blood cell separation apparatus according to Modified Example 4 of the first embodiment;

FIG. 17 is a block diagram illustrating a configuration example of a blood cell separation apparatus according to a second embodiment;

FIG. 18 is a cross-sectional view illustrating a configuration example of a probe cleaning unit in the blood cell separation apparatus according to the second embodiment;

FIG. 19 is a side view illustrating a configuration example of a container cleaning unit in the blood cell separation apparatus according to the second embodiment;

FIG. 20 is a flowchart illustrating an operation example of the blood cell separation apparatus according to the second embodiment;

FIG. 21 is a partial cross-sectional view illustrating an operation example of the blood cell separation apparatus according to the second embodiment;

FIG. 22 is a partial cross-sectional view illustrating an operation example of the blood cell separation apparatus according to the second embodiment that follows FIG. 21;

FIG. 23 is a partial cross-sectional view illustrating a configuration example and operation example of a probe cleaning unit in a blood cell separation apparatus according to Modified Example of the second embodiment;

FIG. 24 is a block diagram illustrating a configuration example of an automatic analysis apparatus according to a third embodiment;

FIG. 25 is a perspective view illustrating a configuration example of an analysis mechanism in the automatic analysis apparatus according to the third embodiment;

FIG. 26 is a flowchart illustrating an operation example of the automatic analysis apparatus according to the third embodiment;

FIG. 27 is a block diagram illustrating a configuration example of an automatic analysis apparatus according to a Modified Example of the third embodiment;

FIG. 28 is a perspective view illustrating a configuration example of an analysis mechanism in the automatic analysis apparatus according to the Modified Example of the third embodiment; and

FIG. 29 is a flowchart illustrating an operation example of the automatic analysis apparatus according to the Modified Example of the third embodiment.

### DETAILED DESCRIPTION

A blood cell separation apparatus according to an embodiment includes a blood dispensing unit, a reagent dispensing unit, and an external force field application unit. The blood dispensing unit dispenses blood into a dispensing container unit from a sample container. The reagent dispensing unit dispenses a blood platelet aggregation reagent for aggregating blood platelets, into the dispensing container unit. The external force field application unit can apply an external force field for separating a blood cell component from the blood, to the dispensing container unit.

Various Embodiments will be described hereinafter with reference to the accompanying drawings.

Hereinafter, embodiments of a blood cell separation apparatus, an automatic analysis apparatus, and a blood cell separation method will be described with reference to the drawings. In the following description, components having substantially the same function and configuration are assigned the same reference numeral, and the redundant description will be given only when necessary.

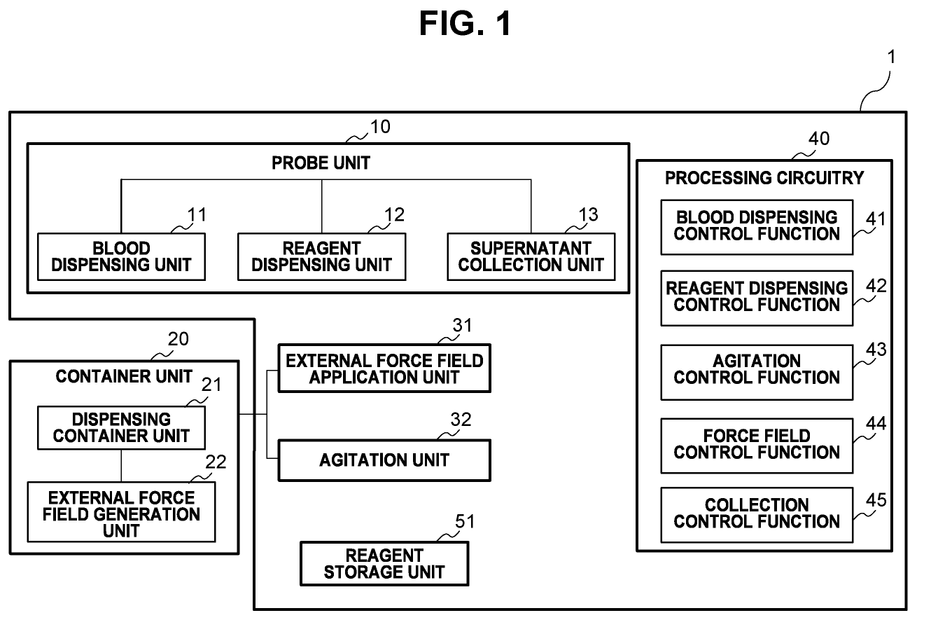

FIG. 1 is a block diagram illustrating a configuration example of a blood cell separation apparatus 1 according to a first embodiment. The blood cell separation apparatus 1 according to the present embodiment is an apparatus that separates a blood cell component from blood by applying an external force field to blood collected from a patient or the like, for example. The external force field is a force field to be artificially applied to blood in a dispensing container unit 21 to be described below, for example, from the outside of the dispensing container unit 21. More specifically, the external force field is a physical force field such as an electric field and an acoustic field, for example. Nevertheless, for the above-described reason, in the present embodiment, a force field to be applied by a centrifuge separator is not included in the external force field.

As illustrated in FIG. 1, the blood cell separation apparatus 1 according to the present embodiment includes, for example, a probe unit 10, an external force field application unit 31, an agitation unit 32, processing circuitry 40, and a reagent storage unit 51. In addition, a container unit 20 is connected to the external force field application unit 31 and the agitation unit 32.

The probe unit 10 includes various probes for performing collection and dispensing of a sample and a reagent in the blood cell separation apparatus 1, for example. The probe unit 10 includes, for example, a blood dispensing unit 11, a reagent dispensing unit 12, and a supernatant collection unit 13. As described below, the blood dispensing unit 11, the reagent dispensing unit 12, and the supernatant collection unit 13 include their respective probes.

The blood dispensing unit 11 dispenses blood into the dispensing container unit 21 from a sample container such as a blood collection tube. The sample container contains blood collected from a patient or the like, for example, in advance.

The reagent dispensing unit 12 dispenses a blood platelet aggregation reagent for aggregating blood platelets, into the dispensing container unit 21. That is, the reagent dispensing unit 12 adds the blood platelet aggregation reagent to blood dispensed into the dispensing container unit 21 by the blood dispensing unit 11. By adding the blood platelet aggregation reagent, blood platelets in blood aggregate to a particle of a size similar to that of a blood cell component larger than the blood platelets, such as the white blood cells and the red blood cells, for example.

The supernatant collection unit 13 collects a supernatant of blood in the dispensing container unit 21. More specifically, the supernatant collection unit 13 collects a supernatant from blood from which a blood cell component has been separated by the external force field. In this specification, the "supernatant" refers to a blood serum component or a blood plasma component contained in blood. In the present embodiment, the supernatant collection unit 13 can collect a supernatant of blood in the dispensing container unit 21 in a state in which the external force field application unit 31 applies the external force field to the dispensing container unit 21. To use the collected supernatant for subsequent analysis, the supernatant collection unit 13 may eject the collected supernatant to a container or the like for analysis.

The container unit 20 includes the dispensing container unit 21 and an external force field generation unit 22. The dispensing container unit 21 is a container to which blood and a blood platelet aggregation reagent are dispensed. The external force field generation unit 22 generates an external force field to be applied to the dispensing container unit 21. Specifically, the external force field generation unit 22 generates at least either one of an electric field and an acoustic wave as an external force field. The container unit 20 is not a component of the blood cell separation apparatus 1.

The external force field application unit 31 can apply an external force field for separating a blood cell component from blood, to the dispensing container unit 21. For example, the external force field application unit 31 is connected to the external force field generation unit 22, and applies the external force field to the dispensing container unit 21 via the external force field generation unit 22.

The agitation unit 32 agitates liquid in the dispensing container unit 21. The liquid in the dispensing container unit 21 is a mixed solution or the like that contains, for example, blood, a blood platelet aggregation reagent, a buffer, or at least two or more of these.

The processing circuitry 40 is control circuitry that controls the entire blood cell separation apparatus 1, and also serves as arithmetic circuitry that performs various types of calculation. In the present embodiment, the processing circuitry 40 includes a blood dispensing control function 41, a reagent dispensing control function 42, an agitation control function 43, a force field control function 44, and a collection control function 45. The details of these functions will be described below.

The reagent storage unit 51 stores a reagent bottle containing the blood platelet aggregation reagent, for example. The reagent storage unit 51 may store a reagent bottle containing one type of blood platelet aggregation reagent, or may store a plurality of reagent bottles respectively containing different blood platelet aggregation reagents.

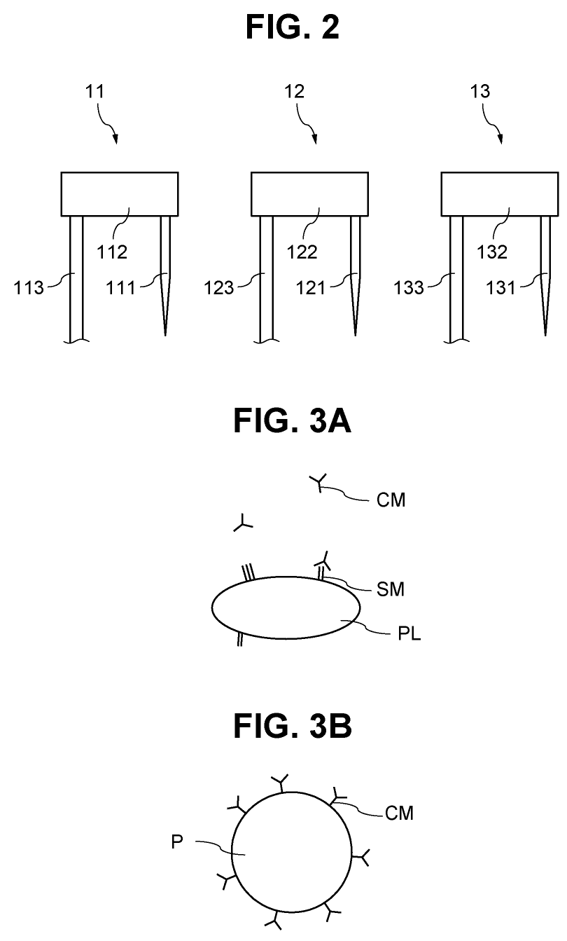

Next, a configuration of the probe unit 10 will be more specifically described with reference to FIG. 2. FIG. 2 is a side view illustrating a configuration example of the probe unit 10 in the blood cell separation apparatus 1 according to the first embodiment.

As illustrated in FIG. 2, the blood dispensing unit 11 includes, for example, a probe 111, an arm 112, and a support shaft 113.

The probe 111 aspirates blood from a sample container, for example. In addition, the probe 111 ejects blood into the dispensing container unit 21. The aspiration and ejection of blood by the probe 111 are driven by a pump included in a drive mechanism (not illustrated), for example.

The arm 112 holds the probe 111 at one end. A different end of the arm 112 is supported by the support shaft 113, for example. The support shaft 113 is provided in a base portion or the like of the blood cell separation apparatus 1 (not illustrated) in such a manner as to be movable up and down and rotatable about a central axis corresponding to an axial direction of the support shaft 113. That is, the arm 112 is provided in such a manner as to be movable up and down in a vertical direction via the support shaft 113 and rotatable in a horizontal direction. The vertical movement and rotation of the arm 112 are driven by the drive mechanism, for example. In accordance with the rotation of the arm 112, the probe 111 rotates along an arc-like rotational trajectory. On the rotational trajectory, for example, a blood aspiration position for aspirating blood from the sample container, and a blood ejection position for ejecting blood into the dispensing container unit 21 are provided. The sample container and the dispensing container unit 21 are set below the blood aspiration position and the blood ejection position, respectively, by a user such as a doctor or a laboratory technician, for example. After the sample container is set at a position different from the blood aspiration position, the sample container may be conveyed to the blood aspiration position by the drive mechanism. Similarly, after the dispensing container unit 21 is set at a position different from the blood ejection position, the dispensing container unit 21 may be conveyed to the blood ejection position by the drive mechanism.

Similarly to the blood dispensing unit 11, the reagent dispensing unit 12 includes, for example, a probe 121, an arm 122, and a support shaft 123.

The probe 121 aspirates a blood platelet aggregation reagent from a reagent bottle arranged in the reagent storage unit 51, for example. In addition, the probe 121 ejects the blood platelet aggregation reagent into the dispensing container unit 21. The aspiration and ejection of the blood platelet aggregation reagent by the probe 121 are driven by the pump included in the drive mechanism, for example.

The arm 122 holds the probe 121 at one end. A different end of the arm 122 is supported by the support shaft 123, for example. The support shaft 123 is provided in a base portion or the like of the blood cell separation apparatus 1 in such a manner as to be movable up and down and rotatable about a central axis corresponding to an axial direction of the support shaft 123. That is, the arm 122 is provided in such a manner as to be movable up and down in the vertical direction via the support shaft 123 and rotatable in the horizontal direction. The vertical movement and rotation of the arm 122 are driven by the drive mechanism, for example. In accordance with the rotation of the arm 122, the probe 121 rotates along an arc-like rotational trajectory. On the rotational trajectory, for example, a reagent aspiration position for aspirating the blood platelet aggregation reagent from a reagent bottle in the reagent storage unit 51, and a reagent ejection position for ejecting the blood platelet aggregation reagent into the dispensing container unit 21 are provided. The reagent ejection position may be the same position as the blood ejection position, or may be a different position. In a case where the reagent ejection position is a position different from the blood ejection position, the dispensing container unit 21 is conveyed by the drive mechanism, for example, from the blood ejection position to the reagent ejection position.

In the present embodiment, an opening portion of the reagent bottle arranged in the reagent storage unit 51 is located at the above-described reagent aspiration position. In a case where a plurality of reagent bottles are arranged in the reagent storage unit 51, a reagent bottle to be used may be conveyed in such a manner that its opening portion is located at the reagent aspiration position. The conveyance of the reagent bottle is driven by the drive mechanism, for example.

In addition, a method by which the reagent dispensing unit 12 dispenses the blood platelet aggregation reagent into the dispensing container unit 21 is not limited to the aspiration and ejection by the probe 121. For example, the probe 121 of the reagent dispensing unit 12 may be fluidically connected with a reagent bottle in the reagent storage unit 51 via a conduit such as a tube, the reagent dispensing unit 12 may send the blood platelet aggregation reagent via the conduit, and the platelet aggregation reagent may be ejected from the probe 121.

Similarly to the blood dispensing unit 11, the supernatant collection unit 13 includes, for example, a probe 131, an arm 132, and a support shaft 133.

The probe 131 aspirates a supernatant from blood separated into a blood cell component and a supernatant in the dispensing container unit 21, for example. To use the collected supernatant for subsequent analysis, the supernatant collection unit 13 may eject the collected supernatant to a container or the like for analysis. The collection and ejection of the supernatant by the probe 131 are driven by the pump included in the drive mechanism, for example.

The arm 132 holds the probe 131 at one end. A different end of the arm 132 is supported by the support shaft 133, for example. The support shaft 133 is provided in a base portion or the like of the blood cell separation apparatus 1 in such a manner as to be movable up and down and rotatable about a central axis corresponding to an axial direction of the support shaft 133. That is, the arm 132 is provided in such a manner as to be movable up and down in the vertical direction via the support shaft 133 and rotatable in the horizontal direction. The vertical movement and rotation of the arm 132 are driven by the drive mechanism, for example. In accordance with the rotation of the arm 132 about the support shaft 133 serving as a rotational shaft, the probe 131 rotates along an arc-like rotational trajectory. On the rotational trajectory, for example, a supernatant collection position for collecting a supernatant from blood in the dispensing container unit 21 is provided. The supernatant collection position may be the same position as the reagent ejection position, or may be a different position. In a case where the supernatant collection position is a position different from the reagent ejection position, the dispensing container unit 21 is conveyed by the drive mechanism, for example, from the reagent ejection position to the supernatant collection position. In addition, on the rotational trajectory of the probe 131, a supernatant ejection position for ejecting a supernatant may be provided.

Next, a blood platelet aggregation reagent to be used in the blood cell separation apparatus 1 according to the present embodiment will be described. The blood platelet aggregation reagent is a reagent for promoting the aggregation of blood platelets, and aggregating blood platelets to a particle larger than a single blood platelet. By adding the blood platelet aggregation reagent to blood, blood platelets contained in the blood aggregate to a particle of a particle diameter of 7 to 20 μm, for example. It accordingly becomes possible to separate particles obtained by aggregating blood platelets, and white blood cells, red blood cells, and the like by the same external force field. The size of the particles obtained by aggregating blood platelets can be adjusted by changing an additive amount, a concentration, or the like of the blood platelet aggregation reagent. In addition, for example, as long as the probe 131 of the supernatant collection unit 13 does not become clogged in a case where the particles obtained by aggregating blood platelets are erroneously aspirated when a supernatant is collected, blood platelets may be aggregated to a particle of a particle diameter larger than 20 μm, by the addition of the blood platelet aggregation reagent.

The blood platelet aggregation reagent includes a blood platelet activation reagent for activating a blood platelet, for example. The blood platelet activation reagent contains, for example, at least one of thrombin receptor activating peptide (TRAP), arachidonic acid (AA), collagen, epinephrine (adrenaline), ristocetin, thromboxane A2 (TAX2), and adenosine diphosphate (ADP). Among these, adenosine diphosphate promotes aggregation of blood platelets faster. For this reason, it is possible to enhance the throughput of the blood cell separation apparatus 1 by using the adenosine diphosphate.

The blood platelet aggregation reagent is not limited to the blood platelet activation reagent. For example, the blood platelet aggregation reagent may contain a capture molecule that can capture a surface marker of the blood platelet. FIG. 3A is a schematic diagram of a blood platelet PL and a capture molecule CM in the blood cell separation apparatus 1 according to the first embodiment.

As illustrated in FIG. 3A, a surface marker SM exists on the blood platelet PL. The surface marker SM is, for example, CD31, CD41, CD61, CD62P, CD63, or the like. The capture molecule CM is an antibody or the like that can be bonded with the surface marker SM by capturing the surface marker SM, for example. The blood platelet PL the surface marker SM of which is captured by the capture molecule CM aggregates to a particle larger than a single blood platelet PL. For example, by the capture molecule CM, bonded with the blood platelet PL, being bonded with another capture molecule CM, or by one capture molecule CM being bonded with a plurality of the blood platelets PL, the blood platelets PL aggregate to a particle larger than a single blood platelet PL.

In addition, the blood platelet aggregation reagent may contain a particle the surface of which is modified by the capture molecule CM. FIG. 3B is a schematic diagram of a particle P modified by the capture molecule CM in the blood cell separation apparatus 1 according to the first embodiment.

As illustrated in FIG. 3B, the surface of the particle P is modified by one or a plurality of capture molecules CM. In the example illustrated in FIG. 3B, the surface of the particle P is modified by the plurality of capture molecules CM, and one particle P can capture a plurality of blood platelets PL. The blood platelet PL accordingly aggregates to a particle larger than a single blood platelet PL. The particle P is, for example, a polymer particle such as a polystyrene particle, a magnetic particle, a metal particle such as a gold nanoparticle, or the like.

In addition, the size of the particle P is about 5 to 15 μm, for example. In this case, the size of the particle P that has captured the blood platelet PL becomes a size similar to that of nucleated blood cells. For this reason, using the same external force field as an external force field for separating nucleated cells from blood, the blood platelet PL can be separated from blood. The size of the particle P may be smaller than 5 μm, or may be larger than 15 μm.

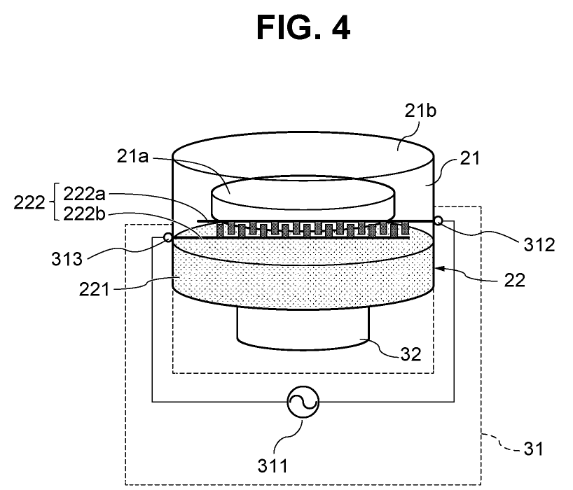

Next, a configuration of the container unit 20 will be more specifically described with reference to FIG. 4. FIG. 4 is a perspective view illustrating a configuration example of the container unit 20 in the blood cell separation apparatus 1 according to the first embodiment. As described above, the container unit 20 includes the dispensing container unit 21 and the external force field generation unit 22.

As illustrated in FIG. 4, the dispensing container unit 21 is provided above the external force field generation unit 22, for example. The material of the dispensing container unit 21 is glass, resin, or the like. In the example illustrated in FIG. 4, the dispensing container unit 21 has a bottom surface 21a and an inclined surface 21b. The inclined surface 21b connects the bottom surface 21a and a side surface of the dispensing container unit 21. By the bottom surface 21a and the inclined surface 21b, a containing portion for containing dispensed blood and blood platelet aggregation reagent is defined. In the present embodiment, the dispensing container unit 21 has a dish-shaped containing portion wider in a traverse direction than in a longitudinal direction. The shape of the dispensing container unit 21 is not limited to the shape illustrated in FIG. 4, and may be any shape. For example, the dispensing container unit 21 may be a bottomed cylindrical shape.

The external force field generation unit 22 is provided below the dispensing container unit 21, for example. As described above, the external force field generation unit 22 generates an external force field to be applied to the dispensing container unit 21. In the present embodiment, the external force field generation unit 22 generates, as an external force field, an electric field, and more specifically, generates an alternating electric field. The blood cell separation apparatus 1 according to the present embodiment can accordingly perform blood cell separation that is based on the principle of dielectrophoretic force.

In the present embodiment, the external force field generation unit 22 includes a support portion 221 and an electrode pair 222. The support portion 221 supports the electrode pair 222. The material of the support portion 221 is glass, resin, or the like. The electrode pair 222 is arranged on the top surface of the support portion 221, for example. The electrode pair 222 is a metal film of copper, indium tin oxide (ITO), or the like, for example.

The electrode pair 222 is a comb-shaped electrode, for example. That is, the electrode pair 222 includes an electrode 222a and an electrode 222b. The electrode 222a and the electrode 222b include base portions extending substantially parallel to each other and a plurality of electrode fingers extending vertically from the base portions. The electrode fingers of the electrode 222a and the electrode fingers of the electrode 222b are alternately arranged along the extending direction of the base portions. That is, the electrode fingers of the electrode 222a and the electrode fingers of the electrode 222b form an interdigital electrode. The shape of the electrode pair 222 is not limited to comb-shaped electrodes as long as the electrodes are arranged in such a manner that an inhomogeneous electric field can be formed, and may be any shape.

In the present embodiment, the external force field generation unit 22 is provided below the dispensing container unit 21, and generates an external force field from below the dispensing container unit 21. Downward dielectrophoretic force accordingly acts on the particles such as red blood cells, white blood cells, and aggregated blood platelets that are included in a blood cell component, and a supernatant and the blood cell component are separated in a vertical direction. The positional relationship between the dispensing container unit 21 and the external force field generation unit 22 is arbitrary, and is not limited to the above-described positional relationship. For example, the external force field generation unit 22 may be provided on a side portion of the dispensing container unit 21, and an external force field may be generated from the lateral side of the dispensing container unit 21. In this case, dielectrophoretic force in the traverse direction acts on the particles contained in the blood cell component, and the supernatant and the blood cell component are separated in a left-right direction, for example.

In addition, in the present embodiment, the external force field generation unit 22 is formed integrally with the dispensing container unit 21. The external force field generation unit 22 may be formed separately from the dispensing container unit 21.

As illustrated in FIG. 4, the external force field application unit 31 and the agitation unit 32 are connected to the dispensing container unit 21 and the external force field generation unit 22. The external force field application unit 31 is provided at an external force field application position for applying an external force field to the dispensing container unit 21, for example, and the agitation unit 32 is provided at an agitation position for agitating the liquid in the dispensing container unit 21, for example. In the example illustrated in FIG. 4, a state in which the external force field application position and the agitation position are provided at the same position, and the dispensing container unit 21 and the external force field generation unit 22 are arranged at the position is illustrated.

The external force field application unit 31 is connected to the external force field generation unit 22 at the external force field application position, and applies an external force field to the dispensing container unit 21 via the external force field generation unit 22.

More specifically, the external force field application unit 31 includes a configuration for generating an alternating electric field in the external force field generation unit 22. The external force field application unit 31 includes, for example, an alternating-current power source 311, a first terminal 312, and a second terminal 313. The alternating-current power source 311 generates an alternating-current voltage. One end and a different end of the alternating-current power source 311 are respectively connected to the first terminal 312 and the second terminal 313. The first terminal 312 and the second terminal 313 are electrically connected with the external force field generation unit 22 located at the external force field application position. More specifically, the first terminal 312 is electrically connected with the electrode 222a of the electrode pair 222, and the second terminal 313 is electrically connected with the electrode 222b of the electrode pair 222. The first terminal 312 and the second terminal 313 include, for example, spring terminals.

If the alternating-current power source 311 of the external force field application unit 31 is turned on, an alternating electric field is generated between the electrode fingers of the electrode 222a and the electrode fingers of the electrode 222b in the external force field generation unit 22, and dielectrophoretic force for separating a blood cell component from blood is generated by the alternating electric field.

The external force field application unit 31 may include a direct-current power source in place of the alternating-current power source 311. In this case, the external force field generation unit 22 generates a direct-current electric field as an external force field. Even in a case where the direct-current electric field is applied as an external force field, the blood cell separation apparatus 1 can perform blood cell separation that is based on the principle of dielectrophoretic force.

In addition, the external force field application unit 31 may be connected with an external power source (not illustrated) instead of including the alternating-current power source 311. In this case, the external force field application unit 31 may include a switch provided between at least one of the first terminal 312 and the second terminal 313, and the external power source, for example.

The agitation unit 32 is connected to the dispensing container unit 21 at the agitation position. In the example illustrated in FIG. 4, the agitation unit 32 is connected to the dispensing container unit 21 via the external force field generation unit 22. The agitation unit 32 may be directly connected to the dispensing container unit 21 not via the external force field generation unit 22. The agitation unit 32 is, for example, a vortex. In this case, the agitation unit 32 agitates liquid in the dispensing container unit 21 by vibration. The agitation unit 32 is connected to the alternating-current power source 311 or the external power source, for example.

The agitation unit 32 is not limited to the vortex, and may be a magnetic stirrer or a probe for agitation. In a case where the agitation unit 32 is the magnetic stirrer, for example, a rotator is arranged in the containing portion of the dispensing container unit 21. In addition, in this case, the agitation unit 32 includes a magnetic field generation unit for rotationally driving the rotator. In a case where the agitation unit 32 is a probe for agitation, for example, the probe of the agitation unit 32 agitates liquid in the dispensing container unit 21 by aspirating and ejecting the liquid. As another example, the agitation unit 32 may be omitted. In this case, for example, liquid in the dispensing container unit 21 is agitated by an external force field generated by the external force field generation unit 22.

In the present embodiment, because the dispensing container unit 21 and the external force field generation unit 22 are integrally formed, the dispensing container unit 21 and the external force field generation unit 22 are conveyed together to the agitation position and the external force field application position by the drive mechanism, for example. In a case where the external force field generation unit 22 is formed separately from the dispensing container unit 21, for example, the external force field generation unit 22 may be provided at the external force field application position, and the dispensing container unit 21 may be conveyed to the agitation position and the external force field application position. In this case, the external force field generation unit 22 may be a component of the blood cell separation apparatus 1.

In addition, in a case where the external force field application position and the agitation position are provided at the same position as in the present embodiment, for example, as illustrated in FIG. 4, the first terminal 312 and the second terminal 313 of the external force field application unit 31 connect to the electrode pair 222 from the side surface of the external force field generation unit 22, and the agitation unit 32 contacts the external force field generation unit 22 from below the external force field application unit 31. It is accordingly possible to simultaneously perform agitation and external force field application. The external force field application position and the agitation position may be positions different from each other. In addition, at least one of the external force field application position and the agitation position may be the same position as the reagent dispensing position, or may be a different position. Nevertheless, in the present embodiment, because it is possible to collect a supernatant while applying an external force field, the external force field application position is provided at the same position as the supernatant collection position.

Hereinafter, referring back to FIG. 1, the details of the functions of the processing circuitry 40 will be described.

The blood dispensing control function 41 controls the dispensing of blood that is to be executed by the blood dispensing unit 11. For example, by controlling the drive mechanism and operating the arm 112 of the blood dispensing unit 11, the blood dispensing control function 41 moves the probe 111 of the blood dispensing unit 11 to the blood aspiration position and the blood ejection position. In addition, by controlling the pump of the drive mechanism, the blood dispensing control function 41 causes the probe 111 to aspirate blood and eject blood from the probe 111. By controlling the drive mechanism, the blood dispensing control function 41 may convey the sample container to the blood aspiration position, and convey the dispensing container unit 21 to the blood ejection position.

The reagent dispensing control function 42 controls the dispensing of the blood platelet aggregation reagent that is to be executed by the reagent dispensing unit 12. For example, by controlling the drive mechanism and operating the arm 122 of the reagent dispensing unit 12, the reagent dispensing control function 42 moves the probe 121 of the reagent dispensing unit 12 to the reagent aspiration position and the reagent ejection position. In addition, by controlling the pump of the drive mechanism, the reagent dispensing control function 42 causes the probe 121 to aspirate and eject the blood platelet aggregation reagent. By controlling the drive mechanism, the reagent dispensing control function 42 may move the dispensing container unit 21 to the reagent ejection position.

The agitation control function 43 controls the operation of the agitation unit 32. For example, by controlling the agitation unit 32, the agitation control function 43 operates and stops the agitation unit 32. By controlling the drive mechanism, the agitation control function 43 may move the dispensing container unit 21 to the agitation position.

The force field control function 44 controls the operation of the external force field application unit 31. For example, by switching on/off of the alternating-current power source 311 included in the external force field application unit 31, the force field control function 44 generates an external force field from the external force field generation unit 22, or stops the generation of the external force field. The force field control function 44 may control the intensity or the like of the external force field by controlling an output voltage and a frequency of the alternating-current power source 311. By controlling the drive mechanism, the force field control function 44 may move the dispensing container unit 21 and the external force field generation unit 22 to the external force field application position.

The collection control function 45 controls the collection of a supernatant that is to be executed by the supernatant collection unit 13. For example, by controlling the drive mechanism and operating the arm 132 of the supernatant collection unit 13, the collection control function 45 moves the probe 131 of the supernatant collection unit 13 to the blood collection position. In addition, by operating the pump of the drive mechanism, the collection control function 45 causes the probe 131 to collect a supernatant. By operating the drive mechanism, the collection control function 45 may move the dispensing container unit 21 to the supernatant collection position. In addition, by moving the probe 131 to the supernatant ejection position, the collection control function 45 may eject a supernatant from the probe 131.

Here, for example, processing functions to be executed by the blood dispensing control function 41, the reagent dispensing control function 42, the agitation control function 43, the force field control function 44, and the collection control function 45, which are the components of the processing circuitry 40 illustrated in FIG. 1, are stored in storage circuitry (not illustrated) in a computer-executable program format. The processing circuitry 40 is a processor, for example. By reading out a program from the storage circuitry and executing the program, the processor constituting the processing circuitry 40 implements a function corresponding to the read program. In other words, the processing circuitry 40 in a state in which programs are read out includes functions illustrated in the processing circuitry 40 in FIG. 1.

FIG. 1 illustrates a case where the blood dispensing control function 41, the reagent dispensing control function 42, the agitation control function 43, the force field control function 44, and the collection control function 45 are implemented by a single piece of the processing circuitry 40, but the embodiment is not limited to this. For example, the processing circuitry 40 may be formed by combining a plurality of independent processors, and these functions may be implemented by each processor executing each program. In addition, the processing functions included in the processing circuitry 40 may be implemented by being integrated or disintegrated into a single piece or a plurality of pieces of processing circuitry, as appropriate.

In addition, the blood dispensing control function 41, the reagent dispensing control function 42, the agitation control function 43, the force field control function 44, and the collection control function 45 each operate based on a program stored in the storage circuitry, for example. At least one of the blood dispensing control function 41, the reagent dispensing control function 42, the agitation control function 43, the force field control function 44, and the collection control function 45 may operate based on input made by the user via an input interface (not illustrated).

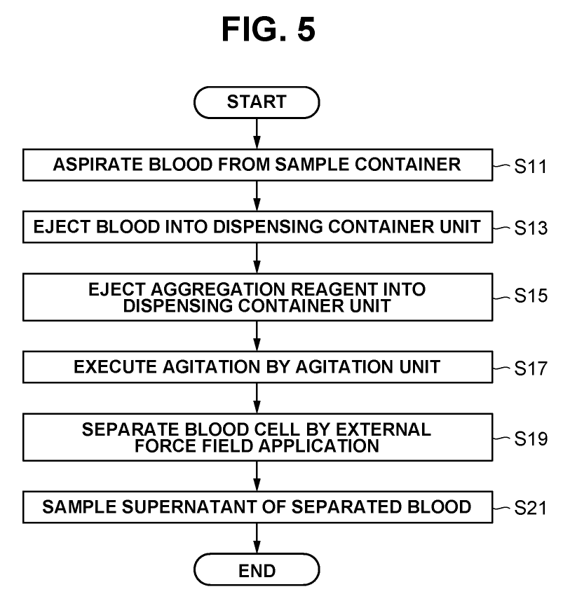

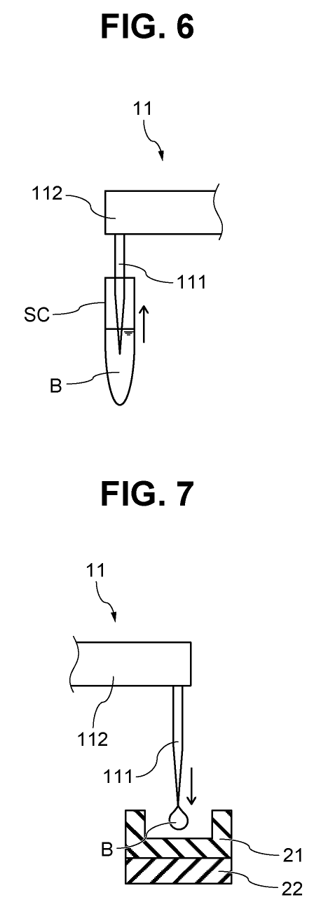

Next, an operation example of the blood cell separation apparatus 1 according to the first embodiment that has the above-described configuration will be described with reference to FIGS. 5 to 11. FIG. 5 is a flowchart illustrating an operation example of the blood cell separation apparatus 1 according to the first embodiment. FIGS. 6 to 11 are partial cross-sectional views each illustrating an operation example of the blood cell separation apparatus 1 according to the first embodiment. The processing in the flowchart illustrated in FIG. 5 starts from a state in which a sample container SC containing blood B is set at the blood aspiration position, and the dispensing container unit 21 is set at the blood ejection position.

First of all, as illustrated in FIG. 5, in step S11, the blood B is aspirated from the sample container SC. More specifically, as illustrated in FIG. 6, the blood dispensing control function 41 of the processing circuitry 40 rotates the arm 112 of the blood dispensing unit 11 and moves the probe 111 to the blood aspiration position. Then, the blood dispensing control function 41 lowers the arm 112 and inserts the leading end of the probe 111 of the blood dispensing unit 11 into the blood B in the sample container SC. Subsequently, the blood dispensing control function 41 causes the probe 111 to aspirate the blood B. Then, the blood dispensing control function 41 raises the arm 112 and moves the probe 111 toward the upper side of the sample container SC.

Next, as illustrated in FIG. 5, in step S13, the blood B is ejected into the dispensing container unit 21. More specifically, as illustrated in FIG. 7, the blood dispensing control function 41 of the processing circuitry 40 rotates the arm 112 of the blood dispensing unit 11 and moves the probe 111 of the blood dispensing unit 11 to the blood ejection position. Then, the blood dispensing control function 41 ejects the blood B in the probe 111 into the dispensing container unit 21.

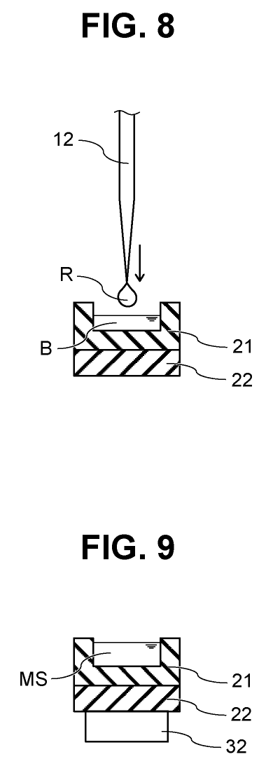

Next, as illustrated in FIG. 5, in step S15, an aggregation reagent is ejected into the dispensing container unit 21. More specifically, as illustrated in FIG. 8, the reagent dispensing control function 42 of the processing circuitry 40 conveys the dispensing container unit 21 to the reagent ejection position. In addition, the reagent dispensing control function 42 moves the probe 121 of the reagent dispensing unit 12 to the reagent aspiration position. Then, the reagent dispensing control function 42 causes the probe 121 to aspirate a blood platelet aggregation reagent R in a reagent bottle. Subsequently, the reagent dispensing control function 42 moves the probe 121 of the reagent dispensing unit 12 to the reagent ejection position. Then, the reagent dispensing control function 42 ejects the blood platelet aggregation reagent R in the probe 121 into the dispensing container unit 21.

Next, as illustrated in FIG. 5, in step S17, the agitation unit 32 performs agitation. More specifically, as illustrated in FIG. 9, the agitation control function 43 of the processing circuitry 40 conveys the dispensing container unit 21 to the agitation position. In addition, the agitation control function 43 operates the agitation unit 32 to agitate mixed solution MS contained in the dispensing container unit 21. The mixed solution MS contains at least the blood B and the blood platelet aggregation reagent R.

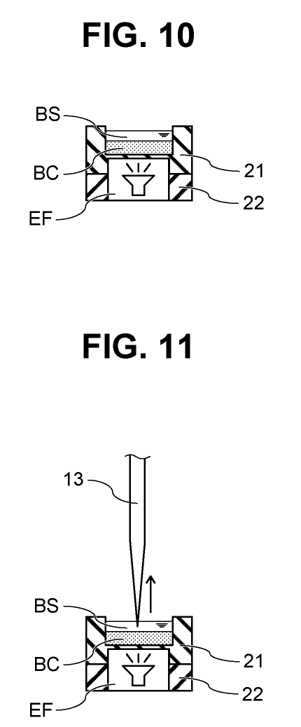

Next, as illustrated in FIG. 5, in step S19, blood cell separation is performed by external force field application. More specifically, as illustrated in FIG. 10, the force field control function 44 of the processing circuitry 40 operates the external force field application unit 31 to apply an external force field EF to the dispensing container unit 21. More specifically, the force field control function 44 turns on the alternating-current power source 311 of the external force field application unit 31 to apply an alternating-current voltage to the external force field generation unit 22. The external force field generation unit 22 to which the alternating-current voltage is applied generates an alternating electric field as the external force field EF. Dielectrophoretic force accordingly acts on various particles contained in the mixed solution MS in the dispensing container unit 21, and the mixed solution MS is separated into a blood cell component BC and a supernatant BS. In the present embodiment, the supernatant BS and the blood cell component BC are separated in the vertical direction in the dispensing container unit 21. The blood cell component BC includes red blood cells, white blood cells, aggregated blood platelets, and the like. In a case where the agitation position and the external force field application position differ from each other, before the external force field EF is applied, the force field control function 44 conveys the dispensing container unit 21 to the external force field application position.

Next, as illustrated in FIG. 5, in step S21, the supernatant BS separated from the blood B is sampled. More specifically, as illustrated in FIG. 11, the collection control function 45 of the processing circuitry 40 moves the probe 131 of the supernatant collection unit 13 to the supernatant collection position. After that, the collection control function 45 moves the probe 131 in such a manner that the leading end of the probe 131 is located in the supernatant BS. Then, in a state in which the external force field EF is applied, the collection control function 45 causes the probe 131 of the supernatant collection unit 13 to aspirate the supernatant BS of the blood B. The application of the external force field EF may be performed also when the probe 131 moves to the supernatant collection position, and also when the leading end of the probe 131 moves into the supernatant BS.

In step S21, by causing the probe 131 of the supernatant collection unit 13 to aspirate the supernatant BS, an operation of the blood cell separation apparatus 1 according to the present embodiment ends. After step S21, the collection control function 45 may move the probe 131 to the supernatant ejection position, and eject the supernatant BS from the probe 131.

Through the above-described steps, the blood cell separation apparatus 1 according to the present embodiment separates the blood B into the blood cell component BC and the supernatant BS. The above-described order of steps S11 to S15 is arbitrary. That is, in the above description, after the blood B is dispensed from the sample container SC into the dispensing container unit 21 in steps S11 and S13, the blood platelet aggregation reagent R is dispensed into the dispensing container unit 21 in step S15. The order is not limited to this. For example, first of all, the processing in step S15 is performed, and after the blood platelet aggregation reagent R is dispensed into the dispensing container unit 21, the blood B may be dispensed from the sample container SC into the dispensing container unit 21 by performing the processing in steps S11 and S13.

As described above, according to the blood cell separation apparatus 1 according to the first embodiment, in a case where the blood cell component BC is separated from the blood B using the external force field EF by adding the blood platelet aggregation reagent R and aggregating the blood platelets PL to a particle of a size similar to that of white blood cells, red blood cells, and the like, it is possible to separate the blood platelet PL using the same force field as that of the blood cell component BC larger than the blood platelet PL.

In addition, according to the present embodiment, by aggregating the blood platelets PL to a particle larger than a single blood platelet PL, it is possible to improve separation performance in separating the blood cell component BC from the blood B by the external force field application unit 31. For this reason, for example, it is possible to prevent blood cells in blood from being destructed by the application of a strong external force field.

In addition, in the present embodiment, the external force field EF different from centrifugal force is applied without using a centrifuge separator. With this configuration, it is possible to automatize processes of blood cell separation in the blood cell separation apparatus 1 while avoiding the upsizing of the blood cell separation apparatus 1.

In addition, in the present embodiment, as compared with a case where the blood B is left stationary after the blood platelet aggregation reagent R is added, it is possible to shorten a time required for blood cell separation by applying the external force field EF. Accordingly, it is possible to enhance the throughput of the blood cell separation apparatus 1.

In addition, in the present embodiment, by the supernatant collection unit 13 collecting the supernatant BS of the blood B in the dispensing container unit 21 in a state in which the external force field EF is applied, it is possible to more surely collect the supernatant BS of the blood B.

In addition, in the present embodiment, by the external force field generation unit 22 being formed integrally with the dispensing container unit 21, for example, a positional relationship between the dispensing container unit 21 and the external force field generation unit 22 is stabilized, and it is possible to stabilize the external force field EF to be applied to the dispensing container unit 21.

In addition, in the present embodiment, by including the agitation unit 32 for agitating the liquid in the dispensing container unit 21, it is possible to promote the aggregation of blood platelets by the blood platelet aggregation reagent R, for example.

The above-described configuration of the dispensing container unit 21 and the external force field generation unit 22 included in the container unit 20 is an example, and various modifications can be made. Hereinafter, Modified Examples 1 to 4 of the first embodiment in which the configuration of the dispensing container unit 21 and the external force field generation unit 22 is changed will be described.

### Modified Example 1 of First Embodiment

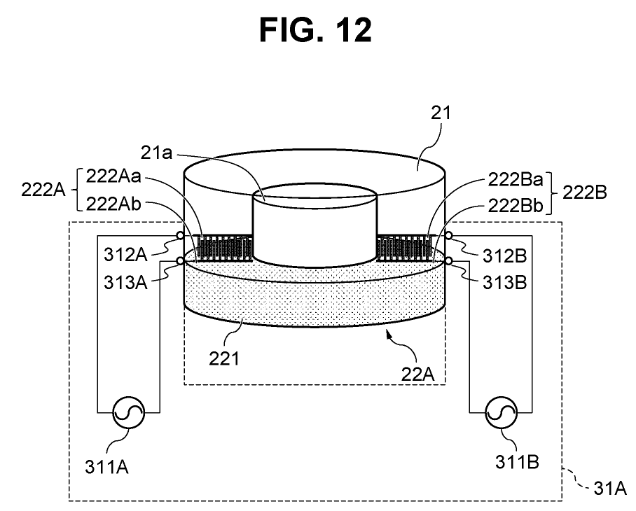

FIG. 12 is a perspective view illustrating a configuration example of a container unit in a blood cell separation apparatus according to Modified Example 1 of the first embodiment. The blood cell separation apparatus according to this modified example is connected to an external force field generation unit 22A that generates surface elastic waves, in place of the external force field generation unit 22 according to the first embodiment. The surface elastic wave is one type of acoustic wave, and is also called a surface acoustic wave. Hereinafter, this modified example will be described mainly based on a difference from the first embodiment.

As illustrated in FIG. 12, the external force field generation unit 22A according to this modified example generates surface elastic waves as an external force field. Specifically, the external force field generation unit 22A includes one or a plurality of acoustic transducers for generating surface elastic waves. In the example illustrated in FIG. 12, the external force field generation unit 22A includes an electrode pair 222A and an electrode pair 222B. Each of the electrode pair 222A and the electrode pair 222B is an acoustic transducer for generating surface elastic waves. In addition, in the present embodiment, at least an upper part of the support portion 221 in the external force field generation unit 22A is formed by a piezoelectric member having a piezoelectric effect property. The external force field generation unit 22A can generate acoustic waves by the acoustic transducer and the piezoelectric member.

The electrode pair 222A is a comb-shaped electrode including an electrode 222Aa and an electrode 222Ab. Similarly, the electrode pair 222B is a comb-shaped electrode including an electrode 222Ba and an electrode 222Bb.

The number of electrode pairs included in the external force field generation unit 22A is not limited to two, and may be any number. For example, the external force field generation unit 22A may include one or three or more electrode pairs. In addition, the shape of electrode pairs included in the external force field generation unit 22A may be any shape, and the electrodes are not limited to comb-shaped electrodes.

In addition, in this modified example, an external force field application unit 31A is provided in place of the external force field application unit 31. The external force field application unit 31A includes two alternating-current power sources 311A and 311B. One end and a different end of the alternating-current power source 311A are respectively connected to a first terminal 312A and a second terminal 313A. The first terminal 312A and the second terminal 313A are electrically connected with the external force field generation unit 22A at the external force field application position. More specifically, the first terminal 312A is electrically connected with the electrode 222Aa of the electrode pair 222A, and the second terminal 313A is electrically connected with the electrode 222Ab of the electrode pair 222A. Similarly, one end and a different end of the alternating-current power source 311B are respectively connected to the first terminal 312B and the second terminal 313B. The first terminal 312B and the second terminal 313B are electrically connected with the external force field generation unit 22A at the external force field application position. More specifically, the first terminal 312B is electrically connected with the electrode 222Ba of the electrode pair 222B, and the second terminal 313B is electrically connected with the electrode 222Bb of the electrode pair 222B. The number of alternating-current power sources included in the external force field application unit 31A is not limited to two, and may be any number. For example, the external force field application unit 31A may include one or three or more alternating-current power sources.

According to this modified example, by using surface elastic waves as an external force field, it is possible to perform blood cell separation that is based on the principle of surface elastic waves. For this reason, for example, it is possible to reduce influence of an electric field on the dispensing container unit 21.

In this modified example, the electrode pair 222 according to the first embodiment may be further provided below the bottom surface 21a of the dispensing container unit 21, and both surface elastic waves and an electric field may be applied as an external force field. With this configuration, for example, it is possible to improve the efficiency of blood cell separation.

In addition, in this modified example, the agitation position and the external force field application position may be provided at the same position, and an external force field may be applied simultaneously with agitation. With this configuration, it is possible to separate the blood cell component BC in the blood B by surface elastic waves, and further promote an aggregation reaction by agitating the blood platelet aggregation reagent R.

In addition, the external force field generation unit 22A may generate acoustic waves other than surface acoustic waves. For example, the external force field generation unit 22A may include an acoustic transducer, and generate ultrasound waves as acoustic waves. In this case, it is possible to perform blood cell separation that is based on the principle of acoustophoresis.

### Modified Example 2 of First Embodiment

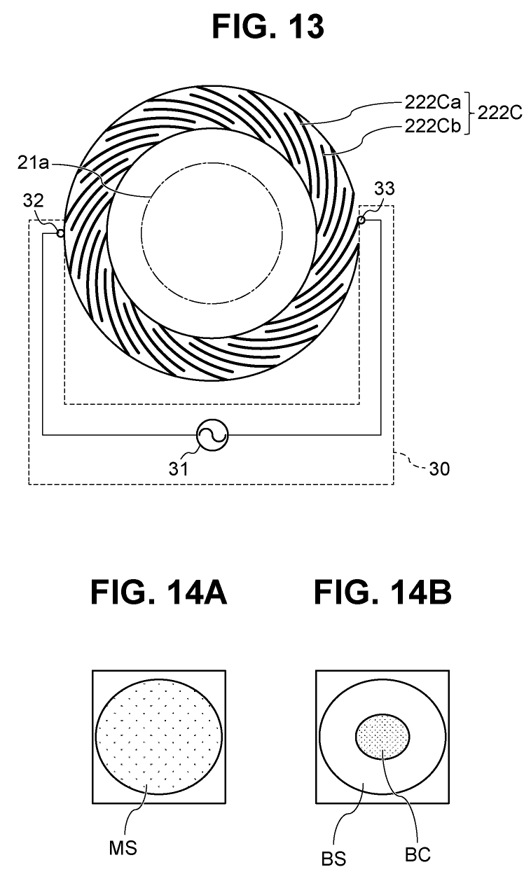

FIG. 13 is a plan view illustrating a configuration example of an external force field generation unit in a blood cell separation apparatus according to Modified Example 2 of the first embodiment. The external force field generation unit according to this modified example includes a spiral comb-shaped electrode in place of the comb-shaped electrode according to Modified Example 1 of the first embodiment.

As illustrated in FIG. 13, the external force field generation unit according to this modified example includes an electrode pair 222C as an acoustic transducer. The electrode pair 222C is a spiral comb-shaped electrode.

The electrode pair 222C includes an electrode 222Ca and an electrode 222Cb. The electrode pair 222C is arranged in such a manner as to surround the bottom surface 21a of the dispensing container unit 21, for example. The external force field generation unit according to this modified example generates spiral surface elastic waves surrounding the mixed solution MS in the dispensing container unit 21. With this configuration, surface elastic waves in a central direction act on the particles such as red blood cells, white blood cells, and the aggregated blood platelets PL that are contained in the blood cell component BC.

In this modified example, the first terminal 312 in the external force field application unit 31 is electrically connected with the electrode 222Ca of the electrode pair 222C, and the second terminal 313 is electrically connected with the electrode 222Cb of the electrode pair 222C.

Hereinafter, an operation example of the blood cell separation apparatus according to this modified example will be described with reference to FIGS. 14A and 14B mainly based on a difference from the first embodiment. FIGS. 14A and 14B are plan views illustrating an operation example of the blood cell separation apparatus according to Modified Example 2 of the first embodiment.

After the aggregation reagent is ejected into the dispensing container unit 21 in step S15 illustrated in FIG. 5, in step S17, agitation is performed by the agitation unit 32. More specifically, as illustrated in FIG. 14A, the agitation control function 43 of the processing circuitry 40 agitates the mixed solution MS contained in the dispensing container unit 21.

Next, as illustrated in FIG. 5, in step S19, blood cell separation is performed by external force field application. As illustrated in FIG. 14B, the mixed solution MS in the dispensing container unit 21 is accordingly separated into the blood cell component BC and the supernatant BS. More specifically, the mixed solution MS is separated in such a manner that the blood cell component BC is gathered to the center of the dispensing container unit 21, and the supernatant BS stays around the blood cell component BC.

Subsequent steps are similar to those in the first embodiment.

According to this modified example, it is possible to perform separation by gathering the blood cell component BC to the center of the dispensing container unit 21 by surface elastic waves. With this configuration, for example, it is possible to simplify the control of the supernatant collection unit 13 in the vertical direction, and prevent the supernatant collection unit 13 from erroneously aspirating the blood cell component BC.

### Modified Example 3 of First Embodiment

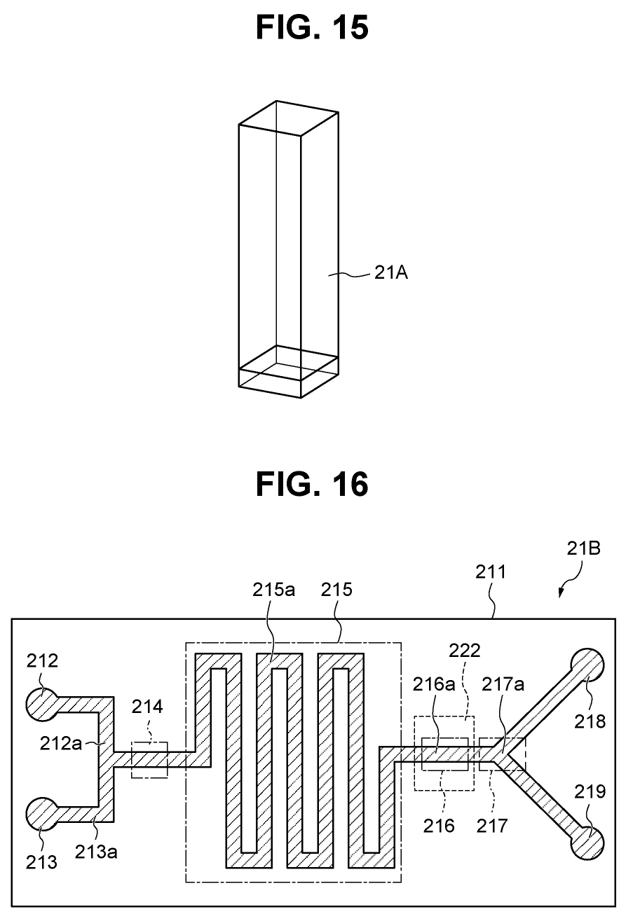

FIG. 15 is a perspective view illustrating a configuration example of a dispensing container unit 21A in a blood cell separation apparatus according to Modified Example 3 of the first embodiment. As illustrated in FIG. 15, in this modified example, the dispensing container unit 21A being an optical cell is used in place of the dispensing container unit 21 according to the first embodiment. The dispensing container unit 21A has at least one light transmissive side surface.

According to this modified example, for example, it is possible to use the dispensing container unit 21A as a reaction tube of an automatic analysis apparatus. The dispensing container unit 21A is arranged in a reaction tank in the automatic analysis apparatus, such as a constant temperature portion 202 to be described below, for example.

### Modified Example 4 of First Embodiment

FIG. 16 is a plan view illustrating a configuration example of a dispensing container unit 21B in a blood cell separation apparatus according to Modified Example 4 of the first embodiment. In this modified example, the dispensing container unit 21B including a microfluidic path is used in place of the dispensing container unit 21 according to the first embodiment.

Hereinafter, an example of the dispensing container unit 21B according to this modified example will be described. As illustrated in FIG. 16, the dispensing container unit 21B is a microfluidic chip including a microfluidic path. The blood B, the blood platelet aggregation reagent R, and the like are conveyed to this microfluidic path.

The dispensing container unit 21B includes a substrate 211, for example. The material of the substrate 211 is glass, for example. Microfluidic paths are formed on the substrate 211. The microfluidic paths include, for example, an inlet 212, a flow path 212a, an inlet 213, a flow path 213a, a flow path 215a, a flow path 216a, a flow path 217a, an outlet 218, and an outlet 219. By these microfluidic paths, for example, a mix region 214, a reaction region 215, an external force field application region 216, and a separation region 217 are provided in the dispensing container unit 21B.

The blood B is dispensed into the inlet 212 by the blood dispensing unit 11, for example. An opening for dispensing the blood B is provided in the substrate 211 at the inlet 212. The blood B dispensed into the inlet 212 is conveyed toward the mix region 214 via the flow path 212a by capillary action, for example.

The blood platelet aggregation reagent R is dispensed into the inlet 213 by the reagent dispensing unit 12, for example. An opening for dispensing the blood platelet aggregation reagent R is provided in the substrate 211 at the inlet 213. The blood platelet aggregation reagent R dispensed into the inlet 213 is conveyed toward the mix region 214 via the flow path 213a by capillary action, for example.

The mix region 214 is a region in which the blood B and the blood platelet aggregation reagent R are mixed. The blood B and the blood platelet aggregation reagent R conveyed to the mix region 214 are mixed in the mix region 214. Then, the mixed solution MS of the blood B and the blood platelet aggregation reagent R is conveyed toward the reaction region 215.

The reaction region 215 is a region in which the blood B and the blood platelet aggregation reagent R undergo reaction in the mixed solution MS. In the example illustrated in FIG. 16, to ensure a time for the blood B and the blood platelet aggregation reagent R to undergo reaction, the winding flow path 215a is provided in the reaction region 215. Then, the mixed solution MS is conveyed toward the external force field application region 216. When the blood B and the blood platelet aggregation reagent R undergo reaction in the reaction region 215, the agitation unit 32 may agitate liquid in the flow path 215a.

The external force field application region 216 is a region in which the external force field EF is applied to the mixed solution MS. In the external force field application region 216, for example, the flow path 216a, and the external force field generation unit 22 provided below the flow path 216a are provided. The external force field generation unit 22 may be formed integrally with the substrate 211 of the microfluidic chip, or may be formed separately therefrom. The mixed solution MS conveyed to the external force field application region 216 is separated into the blood cell component BC and the supernatant BS.

In the separation region 217, the mixed solution MS separated into the blood cell component BC and the supernatant BS is separated into liquid containing the blood cell component BC and liquid containing the supernatant BS. In the separation region 217, a flow path from the external force field application region 216 and the flow path 217a connecting flow paths to the outlet 218 and the outlet 219 are provided. In this modified example, liquid mainly containing the supernatant BS is conveyed to the outlet 218, and liquid mainly containing the blood cell component BC is conveyed to the outlet 219. Thus, the external force field generation unit 22 exerts traverse-direction dielectrophoretic force or the like in the separation region 217, for example.

An opening for the supernatant collection unit 13 to collect the supernatant BS is provided in the substrate 211 at the outlet 218. In addition, an opening for collecting the blood cell component BC is provided in the substrate 211 at the outlet 219.

According to this modified example, it is possible to separate liquid mainly containing the supernatant BS and liquid mainly containing the blood cell component BC into different liquids. For this reason, it is possible to prevent the supernatant collection unit 13 from erroneously aspirating the blood cell component BC for example.

The above-described shape of the microfluidic path is an example, and this modified example is not limited to this. For example, one inlet may be formed in place of the inlet 212 and the inlet 213. In this case, for example, the blood platelet aggregation reagent R is conveyed from the inlet together with the blood B.

### Second Embodiment

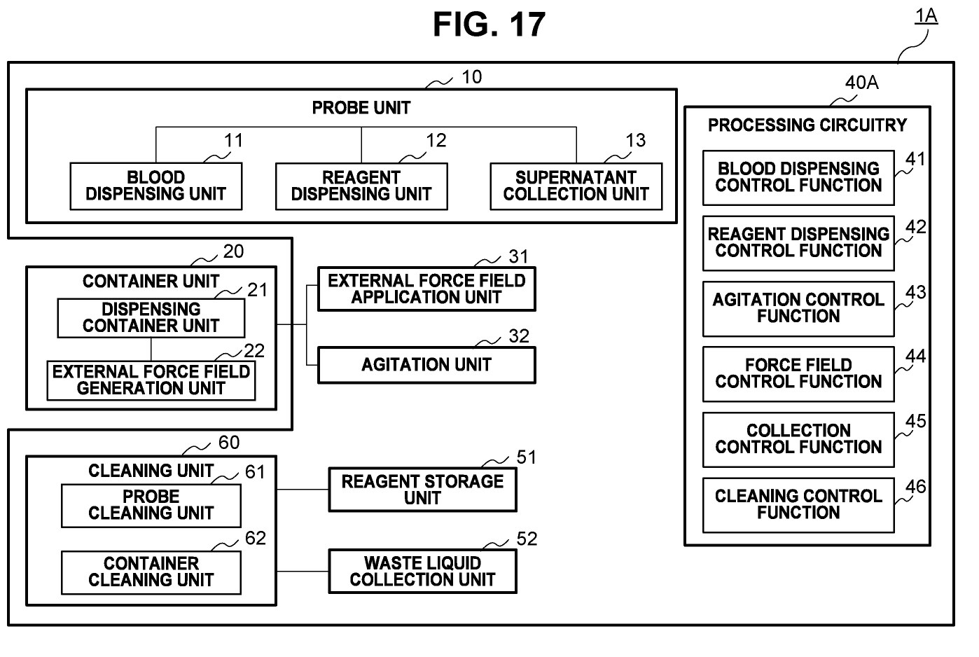

Next, a blood cell separation apparatus 1A according to a second embodiment obtained by adding a cleaning unit that cleans the probe unit 10 and the container unit 20, to the blood cell separation apparatus 1 according to the first embodiment will be described. FIG. 17 is a block diagram illustrating a configuration example of the blood cell separation apparatus 1A according to the second embodiment. Hereinafter, the present embodiment will be described mainly based on a difference from the first embodiment.

As illustrated in FIG. 17, the blood cell separation apparatus 1A according to the present embodiment includes a waste liquid collection unit 52 and a cleaning unit 60 in addition to the blood cell separation apparatus 1 according to the first embodiment.

In addition, in the present embodiment, the dispensing container unit 21 includes a cleanable member such as glass or resin. More specifically, at least a portion of the dispensing container unit 21 that comes into contact with the blood B and the blood platelet aggregation reagent R has a cleanable configuration.

The cleaning unit 60 includes a probe cleaning unit 61 and a container cleaning unit 62. The probe cleaning unit 61 cleans each probe of the probe unit 10. The container cleaning unit 62 cleans the dispensing container unit 21. More specifically, the container cleaning unit 62 cleans at least a portion of the dispensing container unit 21 that comes into contact with the blood B and the blood platelet aggregation reagent R. The probe cleaning unit 61 and the container cleaning unit 62 are connected to the reagent storage unit 51 and the waste liquid collection unit 52.

In the present embodiment, the reagent storage unit 51 further stores a first wash solution bottle containing first wash solution for cleaning each probe of the probe unit 10 and a second wash solution bottle containing second wash solution for cleaning the container cleaning unit 62, for example. The first wash solution is, for example, pure water, alkaline cleaner for probe cleaning, acidic cleaner for probe cleaning, or the like. The second wash solution is, for example, pure water, alkaline cleaner for container cleaning, acidic cleaner for container cleaning, or the like.

The waste liquid collection unit 52 collects the first wash solution used to clean each probe of the probe unit 10 and the second wash solution used to clean the dispensing container unit 21. The waste liquid collection unit 52 includes a bottle for wash solution collection, for example.

In addition, the blood cell separation apparatus 1A according to the present embodiment includes processing circuitry 40A in place of the processing circuitry 40 according to the blood cell separation apparatus 1. The processing circuitry 40A includes a cleaning control function 46 in addition to the functions of the processing circuitry 40. The details of the cleaning control function 46 will be described below.

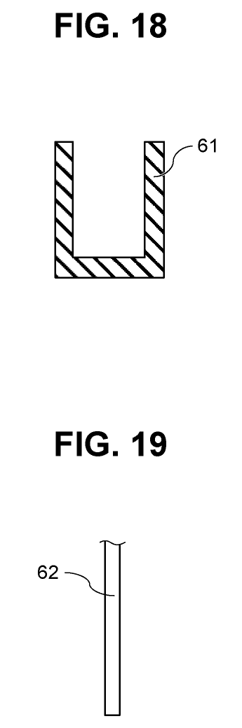

Next, the configuration of the probe cleaning unit 61 will be more specifically described with reference to FIG. 18. FIG. 18 is a cross-sectional view illustrating a configuration example of the probe cleaning unit 61 in the blood cell separation apparatus 1A according to the second embodiment.

As illustrated in FIG. 18, the probe cleaning unit 61 includes a container that can contain the first wash solution, for example. The container of the probe cleaning unit 61 is fluidically connected with the first wash solution bottle arranged in the reagent storage unit 51. The first wash solution in the first wash solution bottle is supplied into the probe cleaning unit 61 by the pump included in the drive mechanism, for example.

Each probe of the probe unit 10 is cleaned by aspirating and ejecting the first wash solution in the probe cleaning unit 61, for example. The aspiration and ejection of the first wash solution are driven by the pump included in the drive mechanism, for example. The first wash solution remaining in the probe cleaning unit 61 after the probes are cleaned is collected into the waste liquid collection unit 52 by the pump included in the drive mechanism, for example. The probe cleaning unit 61 is provided at a probe cleaning position for cleaning the probes, for example. In a case where the probes are sufficiently cleaned by immersing the probes in the first wash solution, the aspiration and ejection of the first wash solution that are to be performed by the probes may be omitted. In addition, the probe cleaning unit 61 may be provided for each probe of the probe unit 10. More specifically, in the blood cell separation apparatus 1A, the probe cleaning unit 61 for cleaning the probe 111 of the blood dispensing unit 11, the probe cleaning unit 61 for cleaning the probe 121 of the reagent dispensing unit 12, and the probe cleaning unit 61 for cleaning the probe 131 of the supernatant collection unit 13 may be provided.

Next, the configuration of the container cleaning unit 62 will be more specifically described with reference to FIG. 19. FIG. 19 is a side view illustrating a configuration example of the container cleaning unit 62 in the blood cell separation apparatus 1A according to the second embodiment.

As illustrated in FIG. 19, the container cleaning unit 62 includes a probe for ejecting the second wash solution into the dispensing container unit 21, for example. The probe of the container cleaning unit 62 is fluidically connected with the second wash solution bottle arranged in the reagent storage unit 51, for example, and the probe aspirates the second wash solution included in the second wash solution bottle and ejects the second wash solution into the dispensing container unit 21. Then, the probe of the container cleaning unit 62 aspirates the second wash solution in the dispensing container unit 21. The dispensing container unit 21 is accordingly cleaned. The aspirated second wash solution is collected into the waste liquid collection unit 52 by the pump included in the drive mechanism, for example. The aspiration and ejection of the wash solution are driven by the pump included in the drive mechanism, for example. The container cleaning unit 62 may include a probe or the like for drying the cleaned dispensing container unit 21. The container cleaning unit 62 is provided at a container cleaning position for cleaning the dispensing container unit 21, for example. The dispensing container unit 21 may be conveyed by the drive mechanism to the container cleaning position.

Referring back to FIG. 17, the cleaning control function 46 controls the cleaning of each probe that is to be executed by the probe cleaning unit 61. For example, by controlling the drive mechanism and operating the arm 112 of the blood dispensing unit 11, the cleaning control function 46 moves the probe 111 of the blood dispensing unit 11 to the probe cleaning position. In addition, by controlling the pump of the drive mechanism, the cleaning control function 46 supplies the first wash solution to the container of the probe cleaning unit 61, and collects the first wash solution from the container. In addition, by controlling the pump of the drive mechanism, the cleaning control function 46 causes the probe 111 to aspirate and eject the first wash solution. Similarly, the cleaning control function 46 moves the probe 121 of the reagent dispensing unit 12 and the probe 131 of the supernatant collection unit 13 to the probe cleaning position, and causes the probe 121 and the probe 131 to aspirate and eject the first wash solution.

In addition, the cleaning control function 46 controls the cleaning of the dispensing container unit 21 that is to be executed by the container cleaning unit 62. For example, by controlling the drive mechanism, the cleaning control function 46 moves the dispensing container unit 21 to the container cleaning position. In addition, by controlling the pump of the drive mechanism, the cleaning control function 46 causes the probe of the container cleaning unit 62 to aspirate and eject the second wash solution.

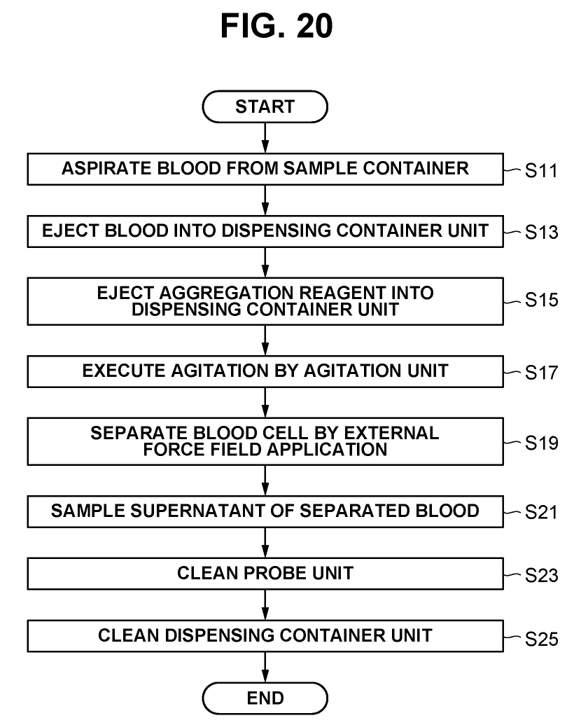

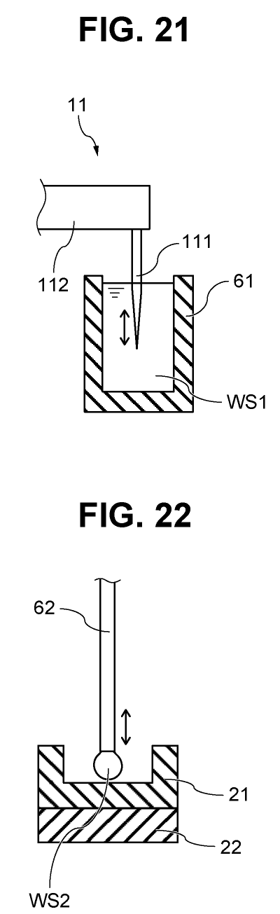

Next, an operation example of the blood cell separation apparatus 1A according to the present embodiment will be described with reference to FIGS. 20 to 22 mainly based on a difference from the first embodiment. FIG. 20 is a flowchart illustrating an operation example of the blood cell separation apparatus 1A according to the second embodiment. FIGS. 21 and 22 are partial cross-sectional views each illustrating an operation example of the blood cell separation apparatus 1A according to the second embodiment.

As illustrated in FIG. 20, after step S21, in step S23, the probe unit 10 is cleaned. More specifically, as illustrated in FIG. 21, the cleaning control function 46 of the processing circuitry 40A moves the probe 111 of the blood dispensing unit 11 to the probe cleaning position. Subsequently, the cleaning control function 46 inserts the leading end of the probe 111 of the blood dispensing unit 11 into a first wash solution WS1 in the probe cleaning unit 61. Then, the cleaning control function 46 causes the probe 111 to aspirate and eject the first wash solution WS1. Similarly, the cleaning control function 46 moves the probe 121 of the reagent dispensing unit 12 and the probe 131 of the supernatant collection unit 13 to their respective probe cleaning positions, and causes the probe 121 and the probe 131 to aspirate and eject the first wash solution WS1.

Next, as illustrated in FIG. 20, in step S25, the dispensing container unit 21 is cleaned. More specifically, as illustrated in FIG. 22, the cleaning control function 46 of the processing circuitry 40A moves the dispensing container unit 21 to a container unit cleaning position. Then, the cleaning control function 46 ejects a second wash solution WS2 from the probe of the container cleaning unit 62. After that, the cleaning control function 46 causes the probe of the container cleaning unit 62 to aspirate the second wash solution WS2.

Through the above-described steps, an operation of the blood cell separation apparatus 1A according to the present embodiment ends.

As described above, according to the blood cell separation apparatus 1A according to the second embodiment, it is possible to clean and repeatedly use the dispensing container unit 21. With this configuration, it is possible to avoid using a disposable member other than a sample container. This is desirable also in the blood cell separation apparatus 1A that processes a number of specimens within a day. Specifically, for example, it is possible to reduce workload of replacement of the dispensing container unit 21 or the like.

In addition, according to the present embodiment, by cleaning each probe of the probe unit 10, it is possible to prevent contamination in the probe unit 10.

The cleaning of each probe of the probe unit 10 in step S23 may be executed immediately after each probe is used. That is, the probe 111 of the blood dispensing unit 11 may be cleaned immediately after the blood dispensing unit 11 is used, the probe 121 of the reagent dispensing unit 12 may be cleaned immediately after the reagent dispensing unit 12 is used, and the probe 131 of the supernatant collection unit 13 may be cleaned immediately after the supernatant collection unit 13 is used.

In addition, in a case where the dispensing container unit 21 is compact, the container cleaning unit 62 may use a cleaning method similar to that of the probe cleaning unit 61. That is, the container cleaning unit 62 may include a container containing the second wash solution, and clean the dispensing container unit 21 by immersing the dispensing container unit 21 in the second wash solution.

Further, the container unit cleaning position may be the same as the agitation position. Alternatively, an agitation unit of the same type as or a different type from the agitation unit 32 may be provided at the container unit cleaning position. With this configuration, it is possible to agitate the dispensing container unit 21 when the dispensing container unit 21 is cleaned and to improve the cleaning efficiency of the dispensing container unit 21.

### Modified Example of Second Embodiment

In the above-described second embodiment, the probe cleaning unit 61 cleans each probe of the probe unit 10 by immersing each probe in the first wash solution in the container of the probe cleaning unit 61. The cleaning method is not limited to this, and the probe cleaning unit 61 may clean each probe by ejecting the first wash solution to each probe of the probe unit 10. Hereinafter, a Modified Example of the second embodiment in which the probe cleaning unit 61 ejects the first wash solution to each probe of the probe unit 10 will be described mainly based on a difference from the above-described second embodiment. In the following description, a case where the probe 111 of the blood dispensing unit 11 is cleaned will be described as an example, but the same applies to the cases where the probe 121 of the reagent dispensing unit 12 and the probe 131 of the supernatant collection unit 13 are cleaned.

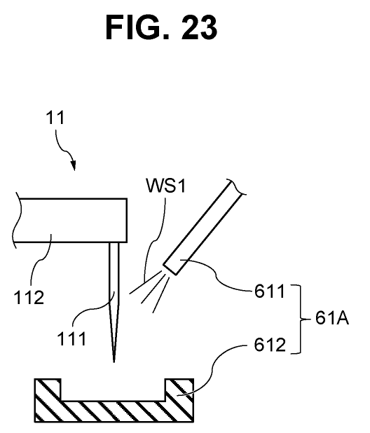

FIG. 23 is a partial cross-sectional view illustrating a configuration example and an operation example of a probe cleaning unit 61A in a blood cell separation apparatus according to the Modified Example of the second embodiment. FIG. 23 illustrates an operation example of the probe cleaning unit 61A in step S23 in FIG. 20.

As illustrated in FIG. 23, the probe cleaning unit 61A according to this modified example includes, for example, a probe 611 and a collection unit 612.

The probe 611 ejects the first wash solution WS1 to the probe 111 of the blood dispensing unit 11, for example. In the example illustrated in FIG. 23, the probe 611 ejects the first wash solution WS1 in such a manner as to be blown on the probe 111. In addition, the probe 611 is fluidically connected with a wash solution bottle arranged in the reagent storage unit 51, for example.

The collection unit 612 collects the first wash solution WS1 that has been blown on the probe 111 of the blood dispensing unit 11 and used to clean the probe 111. The collection unit 612 is fluidically connected with a collection bottle of the waste liquid collection unit 52, for example.

As described above, according to this modified example, it is possible to clean each probe of the probe unit 10 by blowing the first wash solution WS1. With this configuration, for example, it is possible to reduce a used amount of the first wash solution. The cleaning method according to this modified example may be used in combination with the above-described cleaning method according to the second embodiment.

### Third Embodiment

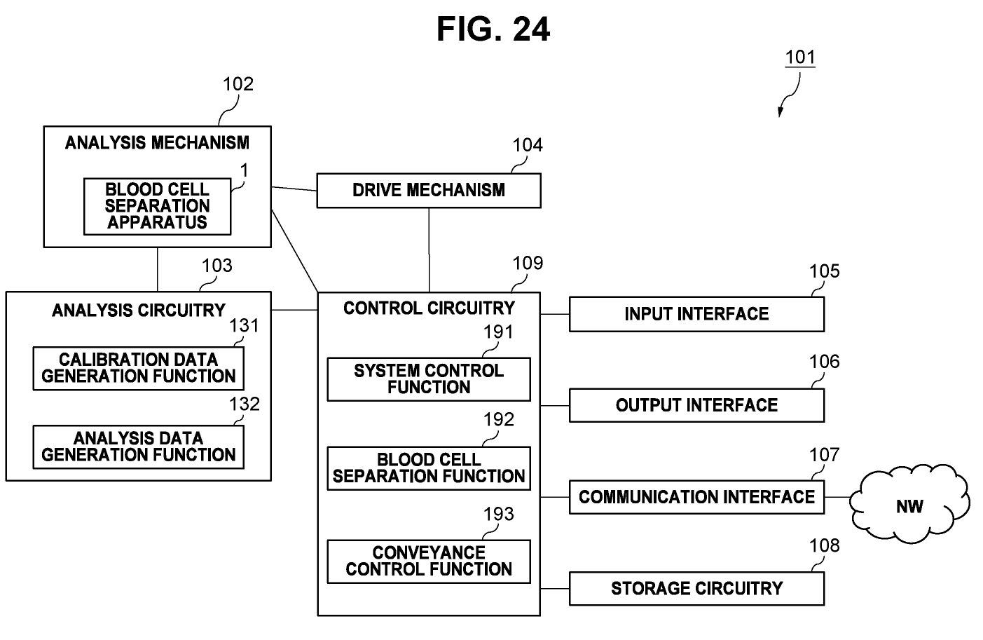

Next, the third embodiment in which the above-described blood cell separation apparatus 1 according to the first embodiment is combined with an automatic analysis apparatus will be described. The automatic analysis apparatus is an apparatus that measures a component in a sample by measuring a reaction liquid of a standard sample and a reagent, a reaction liquid of a test sample and a reagent, or the like, for example. The blood B collected from a patient or the like is an example of a test sample. FIG. 24 is a block diagram illustrating a configuration example of an automatic analysis apparatus 101 according to the third embodiment.

As illustrated in FIG. 24, the automatic analysis apparatus 101 includes, for example, an analysis mechanism 102, analysis circuitry 103, a drive mechanism 104, an input interface 105, an output interface 106, a communication interface 107, storage circuitry 108, and control circuitry 109.

The analysis mechanism 102 mixes a sample such as a standard sample or a test sample with a reagent to be used in each inspection item set for this sample. The analysis mechanism 102 measures a reaction liquid obtained by mixing the reagent with the standard sample, or a reaction liquid of the test sample and the reagent, or the like, and generates standard data and test data, for example. In the present embodiment, the analysis mechanism 102 measures the reaction liquid of the standard sample and the reagent, or the reaction liquid of the test sample and the reagent, for example, and generates the standard data and the test data. Hereinafter, in a case where the standard sample and the test sample will be described without making any distinction, these will sometimes be simply described as "samples".

In addition, in the present embodiment, the analysis mechanism 102 includes the blood cell separation apparatus 1. That is, in the present embodiment, the blood cell separation apparatus 1 is incorporated in the automatic analysis apparatus 101 as a part of the analysis mechanism 102. The blood cell separation apparatus 1 performs preprocessing of the blood B in the case of analyzing the supernatant BS by the automatic analysis apparatus 101, for example.

The analysis circuitry 103 is a processor that generates calibration data, analysis data, and the like by analyzing the standard data and the test data generated by the analysis mechanism 102. The analysis circuitry 103 reads out an analysis program from the storage circuitry 108, and generates calibration data, analysis data, and the like in accordance with the read analysis program. For example, based on the standard data, the analysis circuitry 103 generates calibration data indicating a relationship between the standard data and a standard value preset for the standard sample. In addition, based on the test data and calibration data of an inspection item corresponding to the test data, the analysis circuitry 103 generates analysis data represented as a concentration value and an enzyme activity value. The analysis circuitry 103 outputs the generated calibration data, analysis data, and the like to the control circuitry 109.

In accordance with the control executed by the control circuitry 109, the drive mechanism 104 drives the analysis mechanism 102. For example, the drive mechanism 104 is implemented by a gear, a stepping motor, a belt conveyor, a lead screw, and the like.

The input interface 105 receives the setting of an analysis parameter or the like of each inspection item related to a sample the measurement of which is requested, from the user or via an in-hospital network NW, for example. The input interface 105 is implemented by, for example, a mouse, a keyboard, a touch panel via which an instruction is input by a touch on an operation surface, and the like. The input interface 105 is connected to the control circuitry 109, and converts an operation instruction input from the user, into an electric signal, and outputs the electric signal to the control circuitry 109. In the present embodiment, the input interface 105 is not limited to an input interface including a physical operational component such as a mouse and a keyboard. For example, electric signal processing circuitry that receives an electric signal corresponding to an operation instruction input from an external input device provided separately from the automatic analysis apparatus 101, and outputs the electric signal to the control circuitry 109 is also included in the example of the input interface 105.

The output interface 106 is connected to the control circuitry 109, and outputs a signal supplied from the control circuitry 109. The output interface 106 is implemented by display circuitry, printing circuitry, a voice device, and the like, for example. The display circuitry includes, for example, a cathode-ray tube (CRT) display, a liquid crystal display, an organic electroluminescence (EL) display, a light-emitting diode (LED) display, a plasma display, and the like. Processing circuitry that converts data indicating a display target, into a video signal, and outputs the video signal to the outside is also included in the display circuitry. The printing circuitry includes a printer and the like, for example. Output circuitry that outputs data indicating a printing target, to the outside is also included in the printing circuitry. The voice device includes a speaker and the like, for example. Output circuitry that outputs a voice signal to the outside is also included in the voice device.

The communication interface 107 is connected to the in-hospital network NW, for example, and connects the automatic analysis apparatus 101 to the in-hospital network NW. The communication interface 107 performs data communication with a hospital information system (HIS) via the in-hospital network NW. The communication interface 107 may perform data communication with the HIS via a laboratory information system (LIS) that connects with the in-hospital network NW.

The storage circuitry 108 includes a processor-readable recording medium such as a magnetic recording medium, an optical recording medium, or a semiconductor memory. The storage circuitry 108 needs not always be implemented by a single storage device. For example, the storage circuitry 108 can also be implemented by a plurality of storage devices.

In addition, the storage circuitry 108 stores an analysis program to be executed by the analysis circuitry 103, and a control program to be executed by the control circuitry 109. The storage circuitry 108 stores analysis data generated by the analysis circuitry 103, for each inspection item.

The control circuitry 109 is a processor functioning as a central hub of the automatic analysis apparatus 101. For example, the control circuitry 109 outputs a control signal for driving each component of the analysis mechanism 102, to the drive mechanism 104. In addition, by executing an operation program stored in the storage circuitry 108, the control circuitry 109 implements a function corresponding to the operation program. The control circuitry 109 may include a storage region for storing at least part of data stored in the storage circuitry 108.

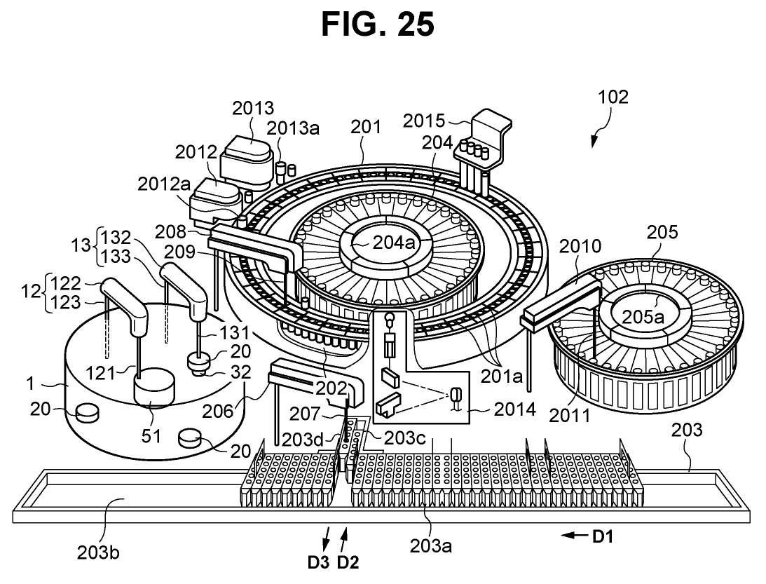

FIG. 25 is a perspective view illustrating a configuration example of the analysis mechanism 102 according to the present embodiment. As illustrated in FIG. 25, the analysis mechanism 102 includes a reaction disk 201, the constant temperature portion 202, a rack sampler 203, a first reagent storage 204, a second reagent storage 205, a sample dispensing arm 206, a sample dispensing probe 207, a first reagent dispensing arm 208, a first reagent dispensing probe 209, a second reagent dispensing arm 2010, a second reagent dispensing probe 2011, a first agitation unit 2012, a second agitation unit 2013, a photometric unit 2014, and a cleaning unit 2015.

The reaction disk 201 holds a plurality of reaction tubes 201a arrayed in an annular shape. The reaction disk 201 conveys the plurality of reaction tubes 201a along a predetermined path. Specifically, during an analysis operation of a reaction liquid of a sample and a reagent, the rotation and stop of the reaction disk 201 are alternately repeated by the drive mechanism 104 at a predetermined time interval. The reaction tube 201a is formed by, for example, glass, polypropylene (PP), or acrylic.

The constant temperature portion 202 stores a heat medium set at a predetermined temperature. By immersing the reaction tubes 201a in the stored heat medium, the constant temperature portion 202 elevates the temperature of the reaction liquid contained in the reaction tubes 201a up to a predetermined temperature and keeps it at the temperature.

The rack sampler 203 movably supports a sample rack 203a that can hold a plurality of sample containers containing samples the measurement of which is requested. The plurality of sample containers contain a specimen such as the blood B the measurement of which is requested. In the example illustrated in FIG. 25, the sample rack 203a that can hold five sample containers in parallel is illustrated.

The rack sampler 203 is provided with a conveyance region 203b in which the sample rack 203a is to be conveyed. That is, using the conveyance region 203b, the sample rack 203a is conveyed from an input position where the sample rack 203a is input, up to a collection position where the sample rack 203a the measurement of which has been completed is collected. In the conveyance region 203b, a plurality of sample racks 203a arrayed in a longitudinal direction is moved by the drive mechanism 104 in a direction D1.

In addition, to move a sample container held in the sample rack 203a, to a predetermined sample aspiration position, a pull-in region 203c for pulling in the sample rack 203a from the conveyance region 203b is provided in the rack sampler 203. The sample aspiration position is provided at a position where the rotational trajectory of the sample dispensing probe 207 and a movement trajectory of an opening portion of a sample container supported by the rack sampler 203 and held in the sample rack 203a intersect with each other, for example. In the pull-in region 203c, the conveyed sample rack 203a is moved in a direction D2 by the drive mechanism 104.

In addition, a return region 203d for returning the sample rack 203a holding a sample container, into which the sample is aspirated, to the conveyance region 203b is provided in the rack sampler 203. In the return region 203d, the sample rack 203a is moved in a direction D3 by the drive mechanism 104.

The first reagent storage 204 keeps a plurality of reagent containers cool. The reagent containers contain a first reagent that reacts with a predetermined component contained in the standard sample and the test sample. The first reagent is buffer solution containing, for example, bovine serum albumin (BSA) or the like. A reagent label is attached to the reagent containers. An optical mark indicating reagent information is printed on the reagent label. As the optical mark, for example, an arbitrary pixel code such as a one-dimensional pixel code and a two-dimensional pixel code is used. The reagent information is information regarding a reagent contained in the reagent container, and includes, for example, a reagent name, a reagent manufacturer code, a reagent item code, a bottle type, a bottle size, capacity, a manufacturing lot number, an expiration date, and the like.

In addition, the first reagent storage 204 keeps a plurality of standard sample containers containing standard samples, cool. The plurality of standard sample containers contain standard samples of the same component with different concentrations. The standard sample containers may be held in a sample rack 2031.

In the first reagent storage 204, a reagent rack 204a is rotatably provided. The reagent rack 204a holds a plurality of reagent containers and a plurality of standard sample containers arrayed in an annular shape. The reagent rack 204a is rotated by the drive mechanism 104. In addition, a reader (not illustrated) that reads reagent information from a reagent label attached to a reagent container is provided in the first reagent storage 204. The read reagent information is stored in the storage circuitry 108.

A first reagent aspiration position is set at a predetermined position on the first reagent storage 204. The first reagent aspiration position is provided at a position where the rotational trajectory of the first reagent dispensing probe 209 and a movement trajectory of the opening portions of the reagent containers and standard sample containers arrayed in an annular shape in the reagent rack 204a intersect with each other, for example.

The second reagent storage 205 keeps a plurality of reagent containers containing a second reagent forming a pair with the first reagent of a two-part reagent, cool. The second reagent is a solution containing an insoluble carrier, such as carrier particles, on which an antigen or an antibody that specifically binds to, or dissociates from, a predetermined antigen or antibody contained in a sample through a specific antigen-antibody reaction is immobilized. The substance that specifically binds to, or dissociates from, the predetermined antigen or antibody by the specific reaction may be an enzyme, a substrate, an aptamer, or a receptor. In the second reagent storage 205, a reagent rack 205a is rotatably provided.

The reagent rack 205a holds a plurality of reagent containers arrayed in an annular shape. In the second reagent storage 205, a standard sample container containing a standard sample may be kept cool. The reagent rack 205a is rotated by the drive mechanism 104. In addition, a reader (not illustrated) that reads reagent information from a reagent label attached to a reagent container is provided in the second reagent storage 205. The read reagent information is stored in the storage circuitry 108.

A second reagent aspiration position is set at a predetermined position on the second reagent storage 205. The second reagent aspiration position is provided at a position where the rotational trajectory of the second reagent dispensing probe 2011 and a movement trajectory of the opening portions of the reagent containers arrayed in an annular shape in the reagent rack 205a intersect with each other, for example.

The sample dispensing arm 206 is provided between the reaction disk 201 and the rack sampler 203. The sample dispensing arm 206 is provided in such a manner as to be movable up and down in the vertical direction and rotatable in the horizontal direction by the drive mechanism 104. The sample dispensing arm 206 holds the sample dispensing probe 207 at one end.

In accordance with the rotation of the sample dispensing arm 206, the sample dispensing probe 207 rotates along an arc-like rotational trajectory. On the rotational trajectory, a sample aspiration position for aspirating a sample from a sample container held in the sample rack 2031 on the rack sampler 203 is provided. In addition, on the rotational trajectory of the sample dispensing probe 207, a sample dispensing position for dispensing the sample aspirated by the sample dispensing probe 207 into the reaction tube 201a is provided. The sample dispensing position is provided at a position where the rotational trajectory of the sample dispensing probe 207 and a movement trajectory of the reaction tube 201a held on the reaction disk 201 intersect with each other.

The sample dispensing probe 207 is driven by the drive mechanism 104, and moves in the vertical direction at the sample aspiration position or the sample dispensing position. Further, in accordance with the control executed by the control circuitry 109, the sample dispensing probe 207 aspirates a sample from a sample container at the sample aspiration position. In addition, in accordance with the control executed by the control circuitry 109, the sample dispensing probe 207 ejects the aspirated sample into the reaction tube 201a located immediately below the sample dispensing position.

The first reagent dispensing arm 208 is provided near the outer circumference of the first reagent storage 204. The first reagent dispensing arm 208 is provided in such a manner as to be movable up and down in the vertical direction and rotatable in the horizontal direction by the drive mechanism 104. The first reagent dispensing arm 208 holds the first reagent dispensing probe 209 at one end.

In accordance with the rotation of the first reagent dispensing arm 208, the first reagent dispensing probe 209 rotates along an arc-like rotational trajectory. On the rotational trajectory, a first reagent aspiration position is provided. The first reagent dispensing probe 209 is provided at the first reagent aspiration position where the first reagent or the standard sample is to be aspirated. The first reagent aspiration position is provided at a position where the rotational trajectory of the first reagent dispensing probe 209 and a movement trajectory of the opening portions of reagent containers or standard sample containers arrayed in an annular shape in the reagent rack 205a intersect with each other, for example. In addition, on the rotational trajectory of the first reagent dispensing probe 209, a first reagent ejection position for ejecting the first reagent or the standard sample aspirated by the first reagent dispensing probe 209, to the reaction tube 201a is set. The first reagent ejection position is provided at a position where the rotational trajectory of the first reagent dispensing probe 209 and a movement trajectory of the reaction tube 201a held on the reaction disk 201 intersect with each other.

The second reagent dispensing arm 2010 is provided near the outer circumference of the first reagent storage 204. The second reagent dispensing arm 2010 is provided in such a manner as to be movable up and down in the vertical direction and rotatable in the horizontal direction by the drive mechanism 104. The second reagent dispensing arm 2010 holds the second reagent dispensing probe 2011 at one end.

In accordance with the rotation of the second reagent dispensing arm 2010, the second reagent dispensing probe 2011 rotates along an arc-like rotational trajectory. On the rotational trajectory, the above-described second reagent aspiration position is provided. Further, on the rotational trajectory of the second reagent dispensing probe 2011, a second reagent ejection position for ejecting the second reagent aspirated by the second reagent dispensing probe 2011 into the reaction tube 201a is set. The second reagent ejection position is provided at a position where the rotational trajectory of the second reagent dispensing probe 2011 and a movement trajectory of the reaction tube 201a held on the reaction disk 201 intersect with each other.

The first agitation unit 2012 is provided near the outer circumference of the reaction disk 201. The first agitation unit 2012 includes a first agitation arm 2012a and a first agitator provided at the leading end of the first agitation arm 2012a. By the first agitator, the first agitation unit 2012 agitates a reaction liquid of the standard sample and the first reagent that is contained in the reaction tube 201a located at a first agitation position on the reaction disk 201. In addition, by the first agitator, the first agitation unit 2012 agitates a reaction liquid of the test sample and the first reagent that is contained in the reaction tube 201a located at the first agitation position on the reaction disk 201.

The second agitation unit 2013 is provided near the outer circumference of the reaction disk 201. The second agitation unit 2013 includes a second agitation arm 2013a and a second agitator provided at the leading end of the second agitation arm 2013a. By the second agitator, the second agitation unit 2013 agitates a reaction liquid of the standard sample, the first reagent, and the second reagent that is contained in the reaction tube 201a located at a second agitation position on the reaction disk 201. In addition, by the second agitator, the second agitation unit 2013 agitates a reaction liquid of the test sample, the first reagent, and the second reagent that is contained in the reaction tube 201a located at the second agitation position.

The photometric unit 2014 optically measures a reaction liquid of the sample, the first reagent, and the second reagent that has been ejected into the reaction tube 201a. The photometric unit 2014 includes a light source and a photodetector. The photometric unit 2014 emits light from the light source in accordance with the control executed by the control circuitry 109. The emitted light enters from a first side wall of the reaction tube 201a and exits from a second side wall facing the first side wall. The photometric unit 2014 detects, by the photodetector, light output from the reaction tube 201a.

Specifically, for example, the photodetector is arranged at a position on an optical axis of light emitted from the light source to the reaction tube 201a. The photodetector detects light transmitted through the reaction liquid of the standard sample, the first reagent, and the second reagent in the reaction tube 201a, and generates standard data represented by absorbance, based on the intensity of the detected light. Further, the photodetector detects light transmitted through the reaction liquid of the test sample, the first reagent, and the second reagent in the reaction tube 201a, and generates test data represented by absorbance, based on the intensity of the detected light. The photometric unit 2014 outputs the generated standard data and the test data to the analysis circuitry 103 as a measurement result.

The cleaning unit 2015 cleans the inside of the reaction tube 201a for which the photometric unit 2014 has finished the measurement of the reaction liquid.

In the present embodiment, the sample dispensing arm 206 and the sample dispensing probe 207 form the blood dispensing unit 11 in the blood cell separation apparatus 1. More specifically, the sample dispensing arm 206 corresponds to the arm 112 of the blood dispensing unit 11, and the sample dispensing probe 207 corresponds to the probe 111 of the blood dispensing unit 11. Further, the blood aspiration position is the same position as the sample aspiration position. Then, in accordance with the control executed by the control circuitry 109, the sample dispensing probe 207 aspirates the blood B from the sample container at the sample aspiration position. In accordance with the control executed by the control circuitry 109, the sample dispensing probe 207 ejects the aspirated sample into the container unit 20 located immediately below the blood ejection position.

In addition, in the present embodiment, the rack sampler 203 corresponds to a conveyance unit that conveys the sample container SC to a position where the blood dispensing unit 11 can aspirate the blood B. In addition, the photometric unit 2014 corresponds to an analysis unit that analyzes the supernatant BS of the blood B separated by the external force field application unit 31.

In addition, in the present embodiment, the container unit 20 is conveyed along a predetermined path in the blood cell separation apparatus 1, for example. A plurality of container units 20 may be arranged in the blood cell separation apparatus 1. With this configuration, it is possible to concurrently perform blood cell separation, and enhance the throughput of the blood cell separation apparatus 1. The plurality of container units 20 are arrayed in an annular shape in the blood cell separation apparatus 1, for example.

In addition, in the present embodiment, the supernatant ejection position is provided at a position where the rotational trajectory of the probe 131 of the supernatant collection unit 13 and a movement trajectory of the reaction tube 201a held on the reaction disk 201 intersect with each other. The supernatant collection unit 13 ejects the collected supernatant into the reaction tube 201a located at the supernatant ejection position.

Referring back to FIG. 24, by executing a control program, for example, the control circuitry 109 implements a system control function 191, a blood cell separation function 192, and a conveyance control function 193. In the present embodiment, a case where the system control function 191, the blood cell separation function 192, and the conveyance control function 193 are implemented by a single processor will be described, but the case is not limited to this. For example, control circuitry may be formed by combining a plurality of independent processors, and the system control function 191, the blood cell separation function 192, and the conveyance control function 193 may be implemented by each processor executing a control program.

The system control function 191 is a function of comprehensively controlling each component in the automatic analysis apparatus 101 based on input information input from the input interface 105. For example, the system control function 191 controls the analysis mechanism 102 in the control circuitry 109, and also controls the analysis circuitry 103 to execute analysis suitable for a measurement item.

The blood cell separation function 192 is a function of controlling the blood cell separation apparatus 1. That is, the blood cell separation function 192 transmits, to the processing circuitry 40 of the blood cell separation apparatus 1, signals required to operate the blood dispensing control function 41, the reagent dispensing control function 42, the agitation control function 43, the force field control function 44, and the collection control function 45 of the processing circuitry 40.

In the present embodiment, the processing circuitry 40 of the blood cell separation apparatus 1 may be omitted. In this case, for example, the blood cell separation function 192 of the control circuitry 109 implements functions of the blood dispensing control function 41, the reagent dispensing control function 42, the agitation control function 43, the force field control function 44, and the collection control function 45 by itself.

The conveyance control function 193 is a function of controlling the conveyance of a sample container or the like by controlling the drive mechanism 104. For example, by controlling the drive mechanism 104 and driving the rack sampler 203, a drive control function 92 moves the sample container held in the sample rack 203a, to the sample aspiration position.

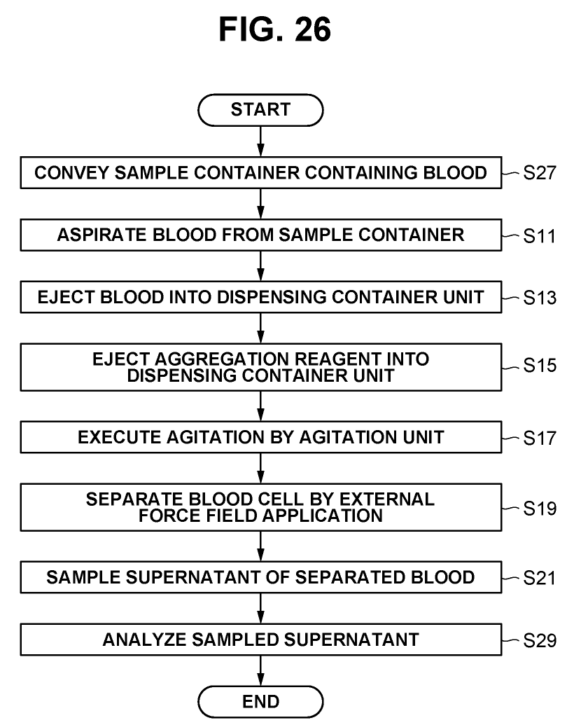

Next, an operation example of the automatic analysis apparatus 101 according to the third embodiment that has the above-described configuration will be described with reference to FIG. 26. FIG. 26 is a flowchart illustrating an operation example of the automatic analysis apparatus 101 according to the third embodiment.

First of all, in step S27, a sample container containing the blood B is conveyed. In the present embodiment, the sample container containing the blood B is held in the sample rack 203a of the rack sampler 203. The conveyance control function 193 of the control circuitry 109 moves the sample container to the sample aspiration position.

Next, by controlling the blood cell separation apparatus 1, the blood cell separation function 192 of the control circuitry 109 performs the processing in steps S11 to S21 similarly to the first embodiment. After step S21, the supernatant BS is collected in the probe 131 of the supernatant collection unit 13.

After step S21, in step S29, the sampled supernatant BS is analyzed. More specifically, first of all, the system control function 191 of the control circuitry 109 moves the probe 131 of the supernatant collection unit 13 to the supernatant ejection position. Then, the system control function 191 ejects the supernatant BS collected by the supernatant collection unit 13, into the reaction tube 201a.

Then, the automatic analysis apparatus 101 performs the analysis of the supernatant BS in the reaction tube 201a. For example, first of all, the first reagent is aspirated by the first reagent dispensing probe 209 from the reagent rack 204a in the first reagent storage 204 and ejected into the reaction tube 201a containing the supernatant BS. Then, a reaction liquid of the supernatant BS and the first reagent that is contained in the reaction tube 201a located at the first agitation position on the reaction disk 201 is agitated by the first agitation unit 2012.

Subsequently, the second reagent is aspirated by the second reagent dispensing probe 2011 from the reagent rack 205a in the second reagent storage 205, and ejected into the reaction tube 201a containing the reaction liquid. Then, a reaction liquid of the supernatant BS, the first reagent, and the second reagent that is contained in the reaction tube 201a located at the second agitation position is agitated by the second agitation unit 2013.

Subsequently, the photometric unit 2014 optically measures the reaction liquid. Then, the system control function 191 may output a measurement result to the output interface 106.

Through the above-described steps, an operation of the automatic analysis apparatus 101 according to the present embodiment ends.

As described above, according to the automatic analysis apparatus 101 according to the third embodiment, it is possible to use the blood cell separation apparatus 1 in combination with the automatic analysis apparatus 101. For this reason, it is possible to automatize blood cell separation and subsequent analysis. In addition, according to the present embodiment, it is possible to combine the automatic analysis apparatus 101 and the blood cell separation apparatus 1 without using a centrifuge separator. For this reason, it is possible to avoid the upsizing of the automatic analysis apparatus 101.

The present embodiment may be combined with Modified Example 3 of the first embodiment in which a dispensing container unit is an optical cell. In this case, the dispensing container unit 21A and the external force field generation unit 22 are provided in the constant temperature portion 202, for example. In addition, the external force field application unit 31 is provided in the constant temperature portion 202, for example, and separates the blood cell component BC in the dispensing container unit 21A. In addition, a reagent bottle containing the blood platelet aggregation reagent R is provided in the first reagent storage 204 or the second reagent storage 205, and the first reagent dispensing probe 209 or the second reagent dispensing probe 2011 implements the function of the probe 121 of the reagent dispensing unit 12. Furthermore, in this case, instead of collecting the supernatant BS by the supernatant collection unit 13, for example, the photometric unit 2014 optically measures the supernatant BS separated in a state in which the external force field EF is applied.

In addition, in the present embodiment, the blood cell separation apparatus 1 is incorporated into the analysis mechanism 102 of the automatic analysis apparatus 101. The configuration is not limited to this, and the blood cell separation apparatus 1 may be externally connected to the automatic analysis apparatus 101.

### Modified Example of Third Embodiment

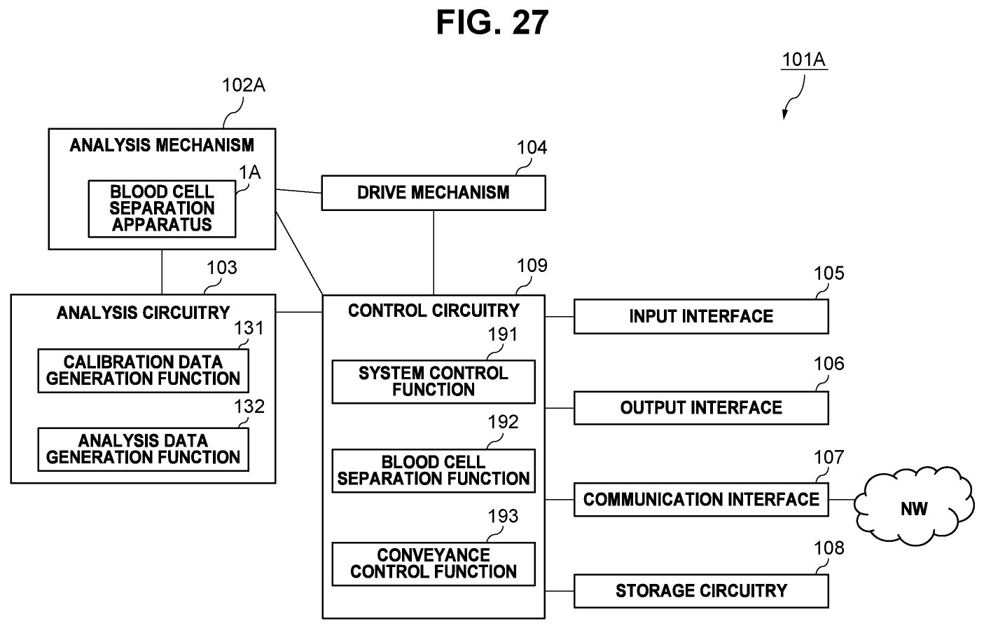

Next, a Modified Example of the third embodiment in which the above-described blood cell separation apparatus 1A according to the second embodiment is combined with an automatic analysis apparatus will be described. That is, this modified example corresponds to a case where a cleaning unit is added to the automatic analysis apparatus 101 according to the third embodiment. FIG. 27 is a block diagram illustrating a configuration example of an automatic analysis apparatus 101A according to the Modified Example of the third embodiment. Hereinafter, this modified example will be described mainly based on a difference from the third embodiment.

As illustrated in FIG. 27, the automatic analysis apparatus 101A according to this modified example includes an analysis mechanism 102A in place of the analysis mechanism 102 of the automatic analysis apparatus 101 according to the third embodiment. The analysis mechanism 102A includes the blood cell separation apparatus 1A in place of the blood cell separation apparatus 1.

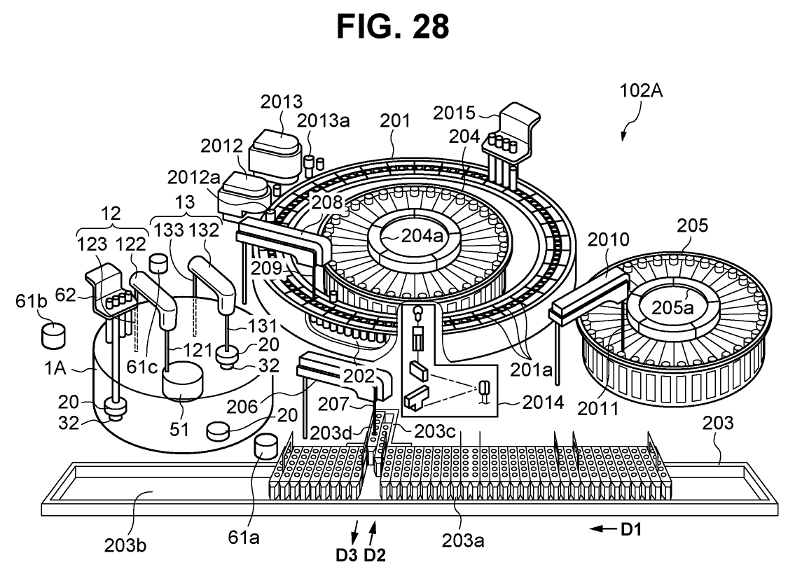

FIG. 28 is a perspective view illustrating a configuration example of the analysis mechanism 102A in the automatic analysis apparatus 101A according to the Modified Example of the third embodiment. As illustrated in FIG. 28, the automatic analysis apparatus 101A further includes the probe cleaning unit 61 and the container cleaning unit 62. In the example illustrated in FIG. 28, the probe cleaning unit 61 is independently provided for each probe of the probe unit 10. More specifically, the automatic analysis apparatus 101A includes a probe cleaning unit 61a for cleaning the probe 111 of the blood dispensing unit 11, a probe cleaning unit 61b for cleaning the probe 121 of the reagent dispensing unit 12, and a probe cleaning unit 61c for cleaning the probe 131 of the supernatant collection unit 13. Among these, the probe cleaning unit 61a is a probe cleaning unit for cleaning the sample dispensing probe 207 of the automatic analysis apparatus 101A. Further, the probe cleaning unit 61b and the probe cleaning unit 61c are newly provided separately from the probe cleaning unit for cleaning the probe of the automatic analysis apparatus 101A. In this manner, the probe cleaning unit 61 may be provided independently of the probe cleaning unit for cleaning the probe of the automatic analysis apparatus 101A, or may be a probe cleaning unit included in the automatic analysis apparatus 101A itself.

Further, in this modified example, the agitation unit 32 is also provided at a container cleaning position where the container cleaning unit 62 is located.

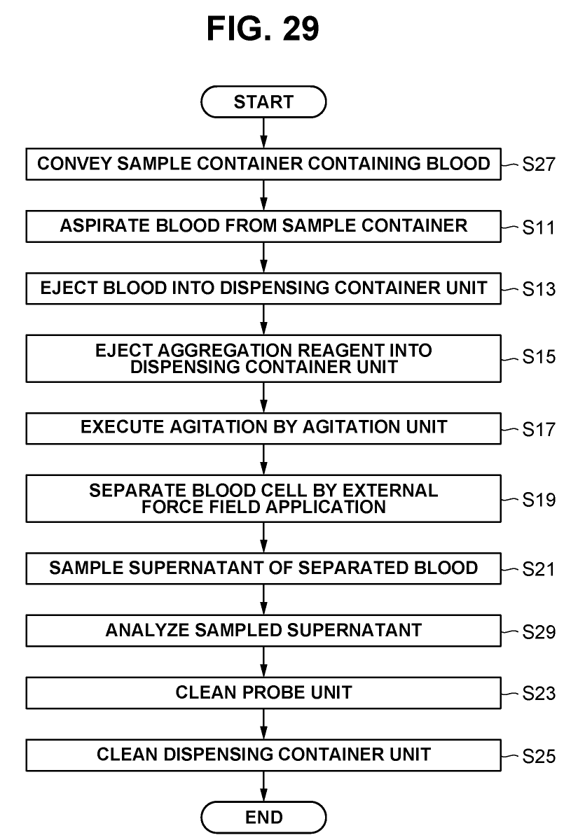

Next, an operation example of the automatic analysis apparatus 101A according to the Modified Example of the third embodiment that has the above-described configuration will be described with reference to FIG. 29. FIG. 29 is a flowchart illustrating an operation example of the automatic analysis apparatus 101A according to the Modified Example of the third embodiment.

As illustrated in FIG. 29, after step S29, the processing in steps S23 and S25 is performed. Because the details of the processing in steps S23 and S25 are similar to those described above, the description will be omitted.

According to this modified example, it is also possible to combine the blood cell separation apparatus 1A including the cleaning unit 60, with the automatic analysis apparatus 101A.

In the above-described third embodiment and the Modified Example of the third embodiment, the application to a biochemical inspection apparatus, which is an automatic analysis apparatus that executes a biochemical inspection, has been described. The application is not limited to this, and the third embodiment and the Modified Example of the third embodiment can be applied to both of an automatic analysis apparatus that executes immunoassay and an automatic analysis apparatus that executes both a biochemical inspection and immunoassay.

The term "processor" used in the above description refers to circuitry such as, for example, a central processing unit (CPU), a graphics processing unit (GPU), an application specific integrated circuit (ASIC), or a programmable logic device (e.g., simple programmable logic device (SPLD), complex programmable logic device (CPLD), and field programmable gate array (FPGA)). The processor implements a function by reading out a program stored in the storage circuitry and executing the program. Instead of storing a program in storage circuitry, a program may be directly installed into circuitry of the processor. In this case, the processor implements a function by reading out the program installed into the circuitry and executing the program. The processor needs not be always formed as circuitry of a single processor, and one processor may be formed by combining a plurality of pieces of independent circuitry to implement the functions. Furthermore, a plurality of components in FIG. 1 may be integrated into one processor, and their functions may be implemented.

According to at least one embodiment described above, in a case where a blood cell component is separated from blood using an external force field, it is possible to separate a blood platelet and a blood cell component larger than the blood platelet, using the same force field.

Heretofore, several embodiments have been described, but these embodiments are presented only as examples, and are not intended to limit the scope of the invention. Novel apparatus and method described in this specification can be executed in other various forms. In addition, various omissions, substitutions, and changes can be made on the configurations of the apparatus and the method described in this specification, without departing from the gist of the invention. The appended claims and the scope equivalent to this are intended to encompass such a configuration and modified examples included in the scope and gist of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A blood cell separation apparatus comprising:
a blood dispensing unit configured to dispense blood from a sample container into a dispensing container unit;
a reagent dispensing unit configured to dispense, into the dispensing container unit, a blood platelet aggregation reagent for aggregating blood platelets; and
an external force field application unit configured to apply an external force field for separating a blood cell component from the blood to the dispensing container unit.

2. The blood cell separation apparatus according to claim 1, wherein the blood platelet aggregation reagent includes a blood platelet activation reagent that activates a blood platelet.

3. The blood cell separation apparatus according to claim 2, wherein the blood platelet activation reagent includes at least one of thrombin receptor activating protein, arachidonic acid, collagen, epinephrine, ristocetin, thromboxane A2, and adenosine diphosphate.

4. The blood cell separation apparatus according to claim 1, wherein the blood platelet aggregation reagent includes a capture molecule that captures a surface marker of a blood platelet.

5. The blood cell separation apparatus according to claim 4, wherein the blood platelet aggregation reagent includes a particle a surface of which is modified by the capture molecule.

6. The blood cell separation apparatus according to claim 1,
wherein the external force field application unit is connected to an external force field generation unit configured to generate the external force field, and
wherein the external force field generation unit generates at least one of an electric field and an acoustic wave as the external force field.

7. The blood cell separation apparatus according to claim 6, wherein the external force field generation unit generates a surface elastic wave as the external force field.

8. The blood cell separation apparatus according to claim 7, wherein the external force field generation unit includes one or a plurality of acoustic transducers for generating the surface elastic wave.

9. The blood cell separation apparatus according to claim 6, wherein the external force field generation unit is formed integrally with the dispensing container unit.

10. The blood cell separation apparatus according to claim 1, further comprising a supernatant collection unit configured to collect a supernatant of the blood in the dispensing container unit in a state in which the external force field application unit applies the external force field.

11. The blood cell separation apparatus according to claim 1, wherein the dispensing container unit includes a microfluidic path to which the blood and the blood platelet aggregation reagent are conveyed.

12. The blood cell separation apparatus according to claim 1, wherein the dispensing container unit made of a cleanable member.

13. The blood cell separation apparatus according to claim 12, further comprising a container cleaning unit for cleaning the dispensing container unit.

14. The blood cell separation apparatus according to claim 1, further comprising an agitation unit for agitating a liquid in the dispensing container unit.

15. An automatic analysis apparatus comprising:
the blood cell separation apparatus according to claim 1.

16. A blood cell separation method comprising:
dispensing blood from a sample container into a dispensing container unit;
dispensing, into the dispensing container unit, a blood platelet aggregation reagent for aggregating blood platelets; and
applying an external force field for separating a blood cell component from the blood to the dispensing container unit.
